(19) United States
(12) Patent Application Publication
(10) Pub. No.: US 2016/0294602 A1
(43) Pub. Date: Oct. 6, 2016

(54) NETWORK CONTROLLER DEVICE

(71) Applicant: yphi inc., Monument, CO (US)

(72) Inventors: James Bentley, Colorado Springs, CO (US); Brandon Jones, Colorado Springs, CO (US); Christopher Lundwall, Monument, CO (US)

(21) Appl. No.: 15/085,144

(22) Filed: Mar. 30, 2016

Related U.S. Application Data
(60) Provisional application No. 62/140,268, filed on Mar. 30, 2015.

(51) Int. Cl. H04L 12/24

(52) U.S. Cl. CPC H04L 41/02; H04L 41/12

(57) ABSTRACT

A network controller device connected to a local area network (LAN) and a wide area network (WAN) is in communication with a communication device through a communication interface. The network controller device communicates with one or more controllable devices, each controlling at least one functionality of a device of a building, using network transmissions through the LAN. The network controller device transmits instructions or receives information from the controller to the controllable devices and communications between the communication device and the controller device includes communications regarding the controllable devices. A newly connected device may be placed into a quarantine status by the controller device. The communication interface may provide an alert to the user regarding an event to the controllable devices.

### CROSS REFERENCE TO RELATED APPLICATION

The present application is claims the benefits of and priority, under 35 U.S.C. §119(e), to U.S. Provisional Application Ser. No. 62/140,268, filed Mar. 30, 2015; the above-identified application being fully incorporated herein by reference.

### BACKGROUND OF THE INVENTION

### Field of the Invention

The invention generally relates to a network controller device, and more particularly to a device, method, and system for controlling devices in a network.

### DISCUSSION OF THE BACKGROUND

A local area network (LAN) is a network that connects network devices, such as computers and smart phones, within a limited and/or confined area such as a residence, school, building, or other areas. A local area network is contrasted to a wide area network (WAN), which covers a larger geographic distance and may involve leased telecommunication circuits, while the media for LANs are usually locally managed. A LAN may serve as a gateway and provide access to a WAN (e.g., the Internet) for network devices that connect to the LAN. Guest devices (e.g., devices that are expected to connect to the LAN for a limited time period and not considered the usual make-up of the LAN) may also be allowed to connect with some LANs and may have limited or full access privileges to services and/or other devices of the LAN as allowed by the individual LANs.

Many LANs are based partly or wholly on wireless technologies. Network devices typically have wireless networking support built-in. In a wireless local area network, users may have relatively unrestricted movement in the coverage area of the wireless network. Wireless networks have become popular in residences and small businesses, because of their ease of installation. Guest devices may also be offered WAN access via a wireless hotspot service. Wireless LANs may work through various wireless protocols such as WiFi, Bluetooth, NFC, etc.

A smart device is a network device that is generally connected to other devices or networks and can operate to some extent interactively and autonomously. Some smart devices may include smart phones, tablets, smart watches, game consoles, or other devices that have functions for interfacing with a user. Other smart devices may include lighting controls, HVACS, security systems, appliances, home and/or building automation systems, or other devices that have non-interface functions. Smart devices (e.g., smart devices for interfacing with a user) may be used to control other smart devices (e.g., smart devices that have non-interface functions) through the network.

A deficiency in the related art is that there is difficulty in organizing smart devices on a network. For example, a home or building may have a number of various types of controllable smart devices (e.g., lighting controls, HVACS, security systems, appliances). These controllable smart devices may also be physically located in various locations (e.g., different rooms of a building). There is difficulty in organizing these devices on the network in correspondence to their physical uses and/or locations for the user.

Another deficiency in the related art is that there is security and access concern to allowing access and control of the controllable smart devices to only authorized and/or allowed users.

Yet another deficiency in the related art is that there is a need for further automation with respect to the control and preference of particular users.

### SUMMARY OF THE INVENTION

There is a need for a network controller device that addresses the deficiencies and problems in the related art.

One advantage of an embodiment of the present invention is that multiple controllable devices on a network may be controlled by one or more network devices in an organized manner. In an embodiment, controllable devices may be organized and filtered in accordance to their locations and/or uses. For example, a set of controllable devices in a particular room of the building may have certain settings different from another set of controllable devices in another room. In an embodiment, these sets of controllable devices may be pre-set prior to a first connection by a user so that the user is able to use the organized devices at his or her first use.

Another advantage of an embodiment of the present invention is providing security access and control to the controllable smart devices for users with various levels of access and/or authority. A further advantage of an embodiment of the present invention is to provide security access and control to new controllable devices connecting to the network.

Yet another advantage of an embodiment of the present invention is to provide further automation with respect to the control and preference of particular users. For example, one user may have his or her own preferences for the various controllable smart devices that is different from other users.

To achieve these and other advantages, as embodied and broadly described, a system for controlling network devices includes a controller device coupled to a local area network (LAN) and a wide area network (WAN) and a communication device including a communication interface. The communication device in communication with the controller device through the communication interface. The controller device communicates with one or more controllable devices using network transmissions through the LAN. The controllable devices each controls at least one functionality of a device of a building. The network transmissions include transmissions for transmitting an instruction from the controller device to the controllable devices or receiving information from the controllable devices to the controller device. Communications between the communication device and the controller device include communications regarding the controllable devices. The controller device provides at least one device connected through the LAN access to the WAN. The communication interface provides a user of the communication device control of at least one of the controllable devices.

In another aspect, the communication interface provides a notification to the user regarding a newly connected of the controllable devices. The newly connected device is placed into a quarantine status by the controller device. The communication interface provides the user options to allow the newly connected device as permanently connected, reject the newly connected device as permanently connected, or continue the quarantine status.

In another aspect, the communication interface provides an alert to the user regarding an event to the controllable devices. The event includes one of (a) one of the controllable devices being placed into a quarantine status; (b) the communication device or the one controllable devices reaching a limit of data transferred or time activated; (c) an activation of an advertisement; and (d) an alert from an external application for the one controllable device.

In another aspect, a set of the controllable devices are grouped by the controller device. The communication interface provides the user a common control for the set. Each device of the set is automatically controlled by the controller device to a predetermined setting when a configuration among the controllable devices, the communication device, the controller device, the user, and other circumstances is reached.

In another aspect, the user is provided with a user account on the controller device, the user account includes an identification of the user and preferences of the user associated with the controllable devices.

In another embodiment, a method for controlling network devices includes providing a controller device coupled to a local area network (LAN) and a wide area network (WAN), providing a communication device to a user, the communication device including a communication interface, communicating the communication device with the controller device through the communication interface, transmitting an instruction from the controller device to one or more controllable devices or receiving information from the controllable devices to the controller device using network transmissions through the LAN, and providing using the controller device at least one device connected through the LAN access to the WAN. The controllable devices each controls at least one functionality of a device of a building. Communications between the communication device and the controller device includes communications regarding the controllable devices. The controller device provides at least one device connected through the LAN access to the WAN. The communication interface provides a user of the communication device control of at least one of the controllable devices.

In another aspect, the method further includes placing a newly connected of the controllable devices is into a quarantine status by the controller device, providing through the communication interface a notification to the user regarding the newly connected device, and providing through the communication interface the user options to allow the newly connected device as permanently connected, reject the newly connected device as permanently connected, or continue the quarantine status.

In another aspect, the method further includes providing through the communication interface an alert to the user regarding an event to the controllable devices. The event includes one of (a) one of the controllable devices being placed into a quarantine status; (b) the communication device or the one controllable devices reaching a limit of data transferred or time activated; (c) an activation of an advertisement; and (d) an alert from an external application for the one controllable device.

In another aspect, a set of the controllable devices are grouped by the controller device. The method further includes providing through the communication interface the user a common control for the set. The method further includes automatically controlling by the controller device each device of the set to a predetermined setting when a configuration among the controllable devices, the communication device, the controller device, the user, and other circumstances is reached.

In another aspect, the method further includes providing the user with a user account on the controller device, the user account includes an identification of the user and preferences of the user associated with the controllable devices.

In yet another embodiment, a method for controlling network devices includes providing a controller device coupled to a local area network (LAN) and a wide area network (WAN), providing a communication device to a user, the communication device including a communication interface, communicating the communication device with the controller device through the communication interface, transmitting an instruction from the controller device to one or more controllable devices or receiving information from the controllable devices to the controller device using network transmissions through the LAN, providing using the controller device at least one device connected through the LAN access to the WAN, placing a newly connected of the controllable devices is into a quarantine status by the controller device, providing through the communication interface a notification to the user regarding the newly connected device, providing through the communication interface the user options to allow the newly connected device as permanently connected, reject the newly connected device as permanently connected, or continue the quarantine status, and providing through the communication interface an alert to the user regarding an event to the controllable devices. The controllable devices each controls at least one functionality of a device of a building. Communications between the communication device and the controller device includes communications regarding the controllable devices. The controller device provides at least one device connected through the LAN access to the WAN. The communication interface provides a user of the communication device control of at least one of the controllable devices.

In another aspect, the event includes one of (a) one of the controllable devices being placed into a quarantine status; (b) the communication device or the one controllable devices reaching a limit of data transferred or time activated; (c) an activation of an advertisement; and (d) an alert from an external application for the one controllable device.

In another aspect, a set of the controllable devices are grouped by the controller device. The method further includes providing through the communication interface the user a common control for the set. The method further includes automatically controlling by the controller device each device of the set to a predetermined setting when a configuration among the controllable devices, the communication device, the controller device, the user, and other circumstances is reached.

In another aspect, providing the user with a user account on the controller device, the user account includes an identification of the user and preferences of the user associated with the controllable devices.

The present disclosure can provide a number of advantages depending on the particular aspect, embodiment, and/or configuration. These and other advantages will be apparent from the disclosure. Additional features and advantages may be learned by the practice of the invention.

### BRIEF DESCRIPTION OF THE DRAWINGS

FIG. 1 illustrates an exemplary block diagram of a communication network according to an embodiment;

FIG. 2 illustrates an exemplary block diagram of a communication network for a network controller device according to an embodiment;

FIGS. 3A-3E illustrate exemplary diagrams of setup processes for a controller device according to an embodiment;

FIGS. 4A-4D illustrate exemplary diagrams of user processes for a controller device according to an embodiment;

FIGS. 5A-5E illustrate exemplary diagrams of device processes for a controller device according to an embodiment;

FIGS. 6A-6C illustrate exemplary diagrams of filter processes for a controller device according to an embodiment;

FIGS. 7A-7B illustrate exemplary diagrams of navigation processes for a controller device according to an embodiment;

FIGS. 8A-8C illustrate exemplary diagrams of data limit processes for a controller device according to an embodiment;

FIGS. 9A-9E illustrate exemplary diagrams of time limit processes for a controller device according to an embodiment;

FIGS. 10A-10P illustrate exemplary diagrams of device control processes for a controller device according to an embodiment;

FIGS. 11A-11C illustrate exemplary diagrams of alarm processes for a controller device according to an embodiment.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The present disclosure can provide a number of advantages depending on the particular aspect, embodiment, and/or configuration. These and other advantages will be apparent from the disclosure.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “module,” as used herein, refers to any known or later developed hardware, software, firmware, artificial intelligence, fuzzy logic, or combination of hardware and software that is capable of performing the functionality associated with that element.

The terms “determine,” “calculate,” and “compute,” and variations thereof, as used herein, are used interchangeably and include any type of methodology, process, mathematical operation or technique.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible, utilizing, alone or in combination, one or more of the features set forth above or described in detail below.

Embodiments herein presented are not exhaustive, and further embodiments may be now known or later derived by one skilled in the art.

Functional units described in this specification and figures may be labeled as modules, or outputs in order to more particularly emphasize their structural features. A module and/or output may be implemented as hardware, e.g., comprising circuits, gate arrays, off-the-shelf semiconductors such as logic chips, transistors, or other discrete components. They may be fabricated with Very-large-scale integration (VLSI) techniques. A module and/or output may also be implemented in programmable hardware such as field programmable gate arrays, programmable array logic, programmable logic devices or the like. Modules may also be implemented in software for execution by various types of processors. In addition, the modules may be implemented as a combination of hardware and software in one embodiment.

An identified module of programmable or executable code may, for instance, include one or more physical or logical blocks of computer instructions that may, for instance, be organized as an object, procedure, or function. Components of a module need not necessarily be physically located together but may include disparate instructions stored in different locations which, when joined logically together, include the module and achieve the stated function for the module. The different locations may be performed on a network, device, server, and combinations of one or more of the same. A module and/or a program of executable code may be a single instruction, or many instructions, and may even be distributed over several different code segments, among different programs, and across several memory devices. Similarly, data or input for the execution of such modules may be identified and illustrated herein as being an encoding of the modules, or being within modules, and may be embodied in any suitable form and organized within any suitable type of data structure.

In one embodiment, the system, components and/or modules discussed herein may include one or more of the following: a server or other computing system including a processor for processing digital data, memory coupled to the processor for storing digital data, an input digitizer coupled to the processor for inputting digital data, an application program stored in one or more machine data memories and accessible by the processor for directing processing of digital data by the processor, a display device coupled to the processor and memory for displaying information derived from digital data processed by the processor, and a plurality of databases or data management systems.

In one embodiment, functional block components, screen shots, user interaction descriptions, optional selections, various processing steps, and the like are implemented with the system. It should be appreciated that such descriptions may be realized by any number of hardware and/or software components configured to perform the functions described. Accordingly, to implement such descriptions, various integrated circuit components, e.g., memory elements, processing elements, logic elements, look-up tables, input-output devices, displays and the like may be used, which may carry out a variety of functions under the control of one or more microprocessors or other control devices.

In one embodiment, software elements may be implemented with any programming, scripting language, and/or software development environment, e.g., Fortran, C, C++, C#, COBOL, Apache Tomcat, Spring Roo, Web Logic, Web Sphere, assembler, PERL, Visual Basic, SQL, SQL Stored Procedures, AJAX, extensible markup language (XML), Arduino, Flex, Flash, Java, .Net and the like. Moreover, the various functionality in the embodiments may be implemented with any combination of data structures, objects, processes, routines or other programming elements.

In one embodiment, any number of conventional techniques for data transmission, signaling, data processing, network control, and the like as one skilled in the art will understand may be used. Further, detection or prevention of security issues using various techniques known in the art, e.g., encryption, may be also be used in embodiments of the invention. Additionally, many of the functional units and/or modules, e.g., shown in the figures, may be described as being “in communication” with other functional units and/or modules. Being “in communication” refers to any manner and/or way in which functional units and/or modules, such as, but not limited to, input/output devices, computers, laptop computers, PDAs, mobile devices, smart phones, modules, and other types of hardware and/or software may be in communication with each other. Some non-limiting examples include communicating, sending and/or receiving data via a network, a wireless network, software, instructions, circuitry, phone lines, Internet lines, fiber optic lines, satellite signals, electric signals, electrical and magnetic fields and/or pulses, and/or the like and combinations of the same.

By way of example, communication among the users, subscribers and/or server in accordance with embodiments of the invention may be accomplished through any suitable communication channels, such as, for example, a telephone network, an extranet, an intranet, the Internet, cloud based communication, point of interaction devices (point of sale device, personal digital assistant, cellular phone, kiosk, and the like), online communications, off-line communications, wireless communications, RF communications, cellular communications, Wi-Fi communications, transponder communications, local area network (LAN) communications, wide area network (WAN) communications, networked or linked devices and/or the like. Moreover, although embodiments of the invention may be implemented with TCP/IP communications protocols, other techniques of communication may also be implemented using IEEE protocols, IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein.

In embodiments of the invention, the system provides and/or receives a communication or notification via the communication system to or from an end user. The communication is typically sent over a network, e.g., a communication network. The network may utilize one or more of a plurality of wireless communication standards, protocols or wireless interfaces (including LTE, CDMA, WCDMA, TDMA, UMTS, GSM, GPRS, OFDMA, WiMAX, FLO TV, Mobile DTV, WLAN, and Bluetooth technologies), and may be provided across multiple wireless network service providers. The system may be used with any mobile communication device service (e.g., texting, voice calls, games, videos, Internet access, online books, etc.), SMS, MMS, email, mobile, land phone, tablet, smartphone, television, vibrotactile glove, voice carry over, video phone, pager, relay service, teletypewriter, and/or GPS and combinations of the same.

Reference will now be made in detail to an embodiment of the present invention, an example of which is illustrated in the accompanying drawings.

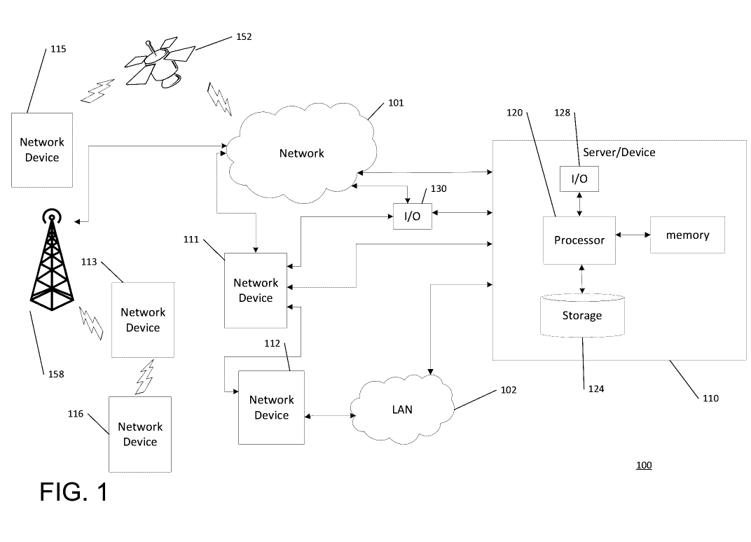

FIG. 1 illustrates an exemplary block diagram of a communication network according to an embodiment.

Referring to FIG. 1, communication network 100 includes one or more networks, including wide-area network 101, e.g., the Internet, company or organization intranet, and/or sections of the Internet (e.g., virtual private networks, cloud, and the deep net), and local-area network 102, e.g., interconnected computers localized at a geographical and/or organization location and ad-hoc networks connected using various wired means, e.g., Ethernet, coaxial, fiber optic, and other wired connections, and wireless means, e.g., Wi-Fi, Bluetooth, and other wireless connections. Communication network 100 includes a number of network devices 110-115 that are in communication with the other devices through the various networks 101 and 102 and through other means, e.g., direct connection through an input/output port of a network device 130, direct connection through a wired or wireless means, and indirect connection through an input-output box, e.g., a switch.

Network devices 110-115, which may also connect through the networks 101 and 102 using various routers, access points, and other means. For example, network device 113 wirelessly connects to a base station 158, which acts as an access point to the wide area network 101. Base station 158 may be a cellular phone tower, a Wi-Fi router or access point, or other devices that allow a network device, e.g., wireless network device 113, to connect to a network, e.g., wide area network 101, through the base station 158. Base station 158 may be connected directly to network 101 through a wired or wireless connection or may be routed through additional intermediate service providers or exchanges. Wireless device 113 connecting through base station 158 may also act as a mobile access point in an ad-hoc or other wireless network, providing access for network device 115 through network device 113 and base station 158 to network 101.

In some scenarios, there may be multiple base stations, each connected to the network 101, within the range of network device 113. In addition, a network device, e.g., network device 113, may be travelling and moving in and out of the range of each of the multiple base stations. In such case, the base stations may perform handoff procedures with the network device and other base stations to ensure minimal interruption to the network device's connection to network 101 when the network device is moved out of the range of the handling base station. In performing the handoff procedure, the network device and/or the multiple base stations may continuously measure the signal strength of the network device with respect to each base station and handing off the network device to another base station with a high signal strength to the network device when the signal strength of the handling base station is below a certain threshold.

In another example, a network device, e.g., network device 115, may wirelessly connect with an orbital satellite 152, e.g., when the network device is outside of the range of terrestrial base stations. The orbital satellite 152 may be wirelessly connected to a terrestrial base station that provides access to network 101 as known in the art.

In other cases, orbital satellite 152 or other satellites may provide other functions such as global positioning and providing the network device with location information or estimations of location information of the network device directly without needing to pass information to the network 101. The location information or estimation of location information is known in the art. The network device may also use geolocation methods, e.g., measuring and analyzing signal strength, using the multiple base stations to determine location without needing to pass information to the network 101. In an embodiment, the global positioning functionality of the orbital satellite 152 may use a separate interface than the communication functionality of the orbital satellite 152 (e.g., the global position functionality uses a separate interface, hardware, software, or other components of the network device 113 than the communication functionality). In another embodiment, the orbital satellite with the global position functionality is a physically separate satellite from the orbital satellite with communication functionality.

In one scenario, network device, e.g., network device 112, may connect to wide area network 101 through the local area network 102 and another network device, e.g., network device 110. Here, the network device 110 may be a server, router, gateway, or other devices that provide access to wide area network 101 for devices connected with local area network 102 (e.g., network device 111 providing access to network 101 or network device 112 providing access to network 102).

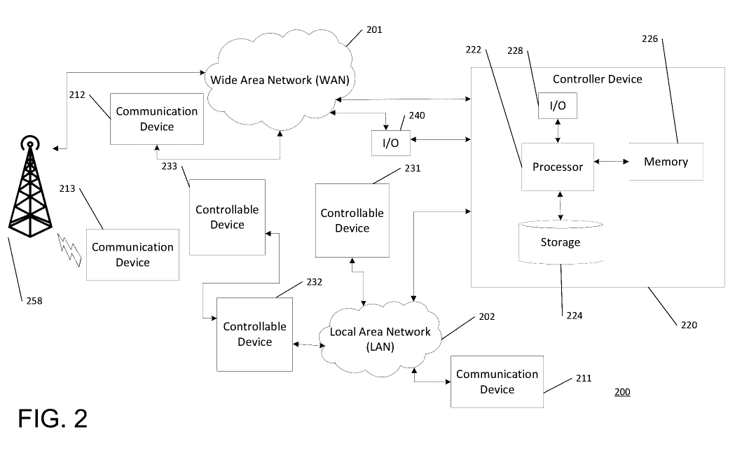

FIG. 2 illustrates an exemplary block diagram of a communication network for a network controller device according to an embodiment.

Referring to FIG. 2, communication network 200 includes a wide area network (WAN) 201 and a local area network (LAN) 202. The WAN 201 may be part of the Internet, company or organization intranet, and/or sections of the Internet (e.g., virtual private networks, cloud, and the deep net). The LAN 202 may be a network within a limited or confined area, e.g., interconnected computers localized at a geographical and/or organization location. The communication network 200 further includes the controllable devices 231-233, communication devices 211-213, and controller device 220.

The controllable devices 231-233 may be various functional smart devices located within the area of the LAN and predominately connects to the LAN 202. Examples of controllable devices 231-233 may include lighting controls, HVACS, security systems, appliances, and other home and/or building automation devices.

The controller device 220 also connects to the LAN 202 and may be used to interface with the controllable devices 231-233 for providing commands to the controllable devices 231-233 or receiving notifications from the controllable devices. In an embodiment, the controller device 220 may also connect with the WAN 201. For example, the controller device 220 may act as a network hub for the LAN 202 and also as a router for connecting the LAN 202 to the WAN 201.

The communication devices 211-213 may include devices such as computers, laptops, smart phones, or other devices providing an interface to a user for sending various instructions to the controller device 220 or receiving notifications from the controller device 220. In an embodiment, the communication devices 211-213 may include an app or other software application specifically for interfacing with the controller device 220, the controller device 220 in turn interfaces with the controllable devices 231-233. In an embodiment, the communication devices 211-213 may interface with the controller device 220 through the WAN 201 (e.g., communication device 212 and communication device 213 through a cell tower 258 wirelessly). In a further embodiment, communication devices 211-213 may also interface with the controllable devices 231-233 directly (e.g., through an app specifically for controlling the controllable devices 231-233) while also separately interface with the controller device 220.

It is noted that communication network 200 may be a simplification of a communication network for mainly showing the interactions of the controllable devices 231-233, controller device 220, and communication devices 211-213 through the LAN 202 and the WAN 201. In an embodiment, other communications networks (e.g., communication network 100) may also be used as can be realized by one skilled in the art (e.g., satellite 152 may be used for the connection of a communication device to the WAN 201.

In an embodiment, controller device 220 may be a router (or other device) loaded with software (e.g., script) for interfacing with the controllable devices 231-233 and/or the communications devices 211-213. For example, controller device 220 may be a router running DD-WRT, where scripts are loaded for interfacing with the controllable devices 231-233 and/or the communications devices 211-213. In another embodiment, the controllable device 220 may be pre-deployed with the interface functionalities. In yet another embodiment, controller device 220 may be a device without router functionality (e.g., connected to LAN 202 but not to WAN 201 without another router).

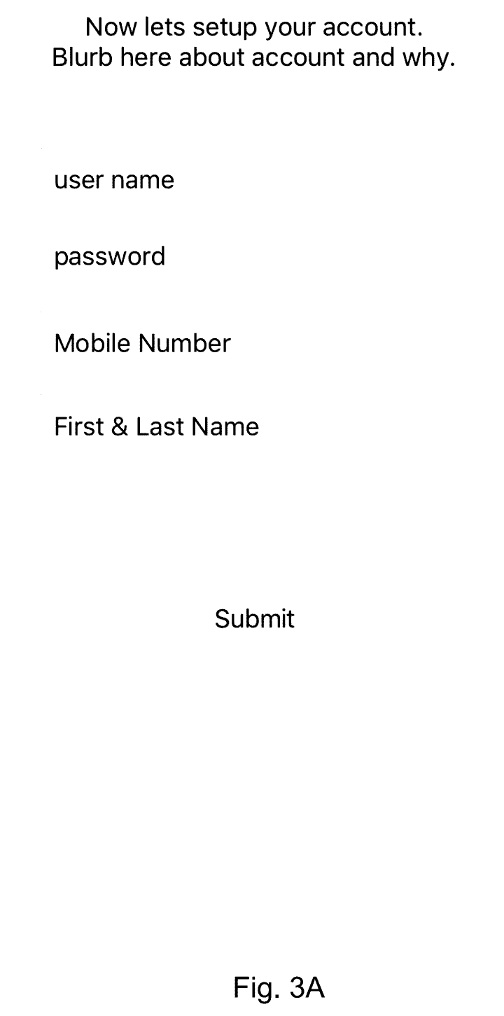

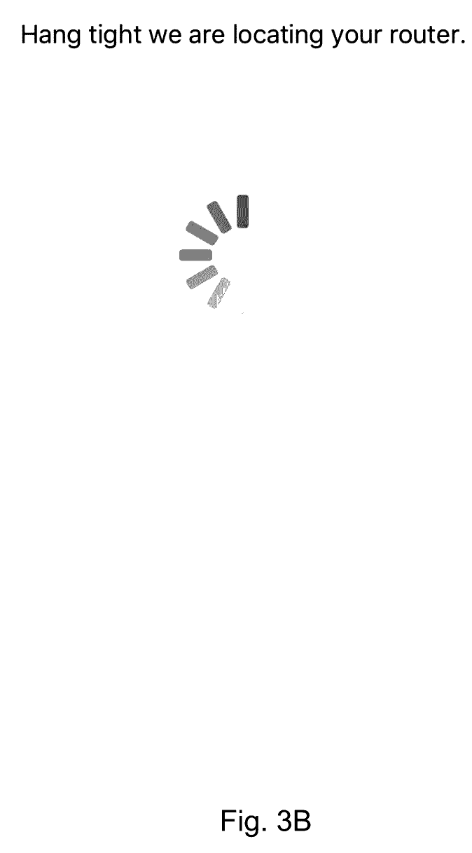

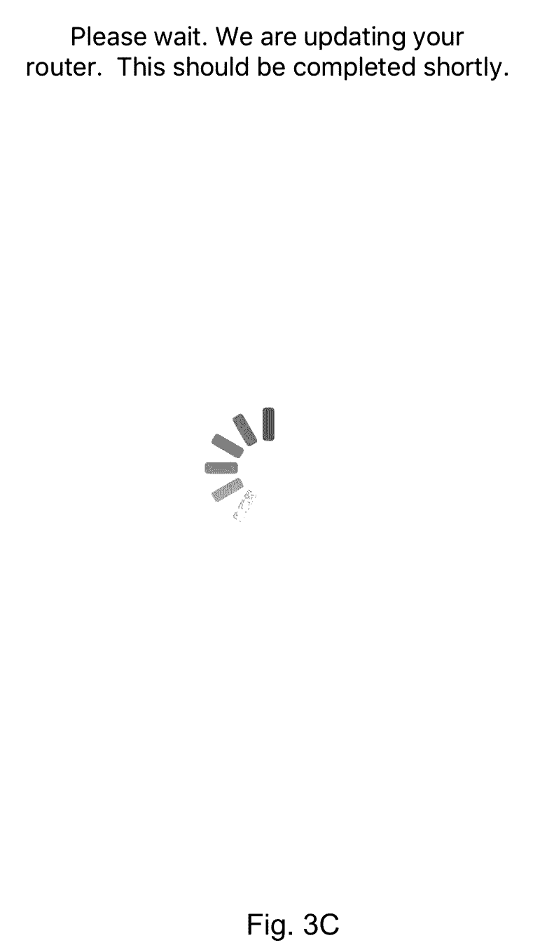

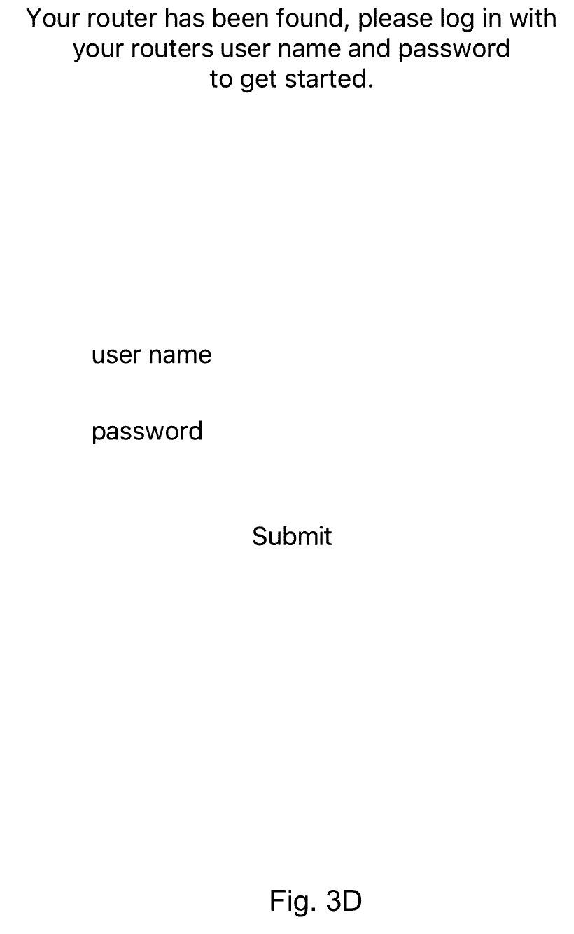

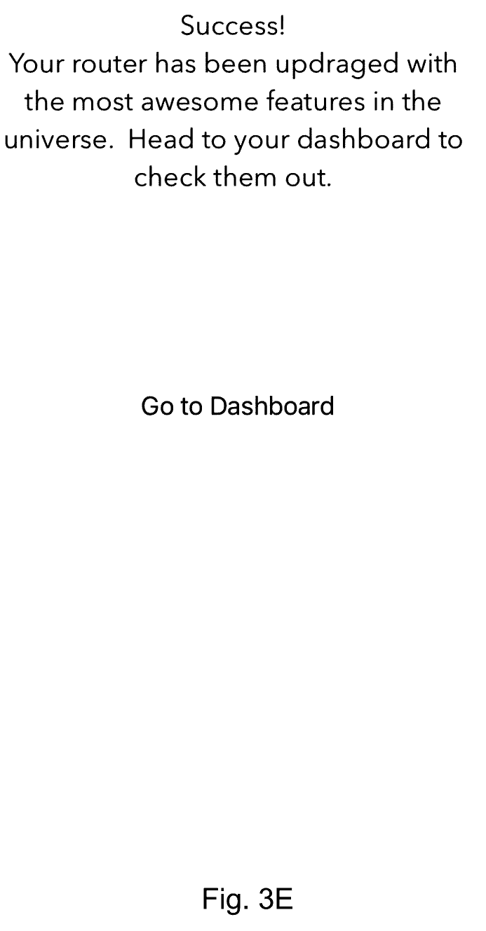

FIGS. 3A-3E illustrate exemplary diagrams of setup processes for a controller device according to an embodiment.

FIG. 3A illustrates an exemplary setup of a user account. The setup process may be provided in a communication device. The user account may include the information related to the user (e.g., user name, password, mobile number for the smart phone, etc.) and may be used for storing and using preferences for the controller device or the controllable devices of the user.

FIG. 3B illustrates an exemplary setup process of locating a controller device. For example, the communication device that the user is using may be connected to the same LAN as the controller device being located, and the setup process is able to locate the controller device on the same LAN.

FIG. 3C illustrates an exemplary setup process for updating a controller device. In an embodiment, the controller device may be updated (e.g., with software codes) through the communication device.

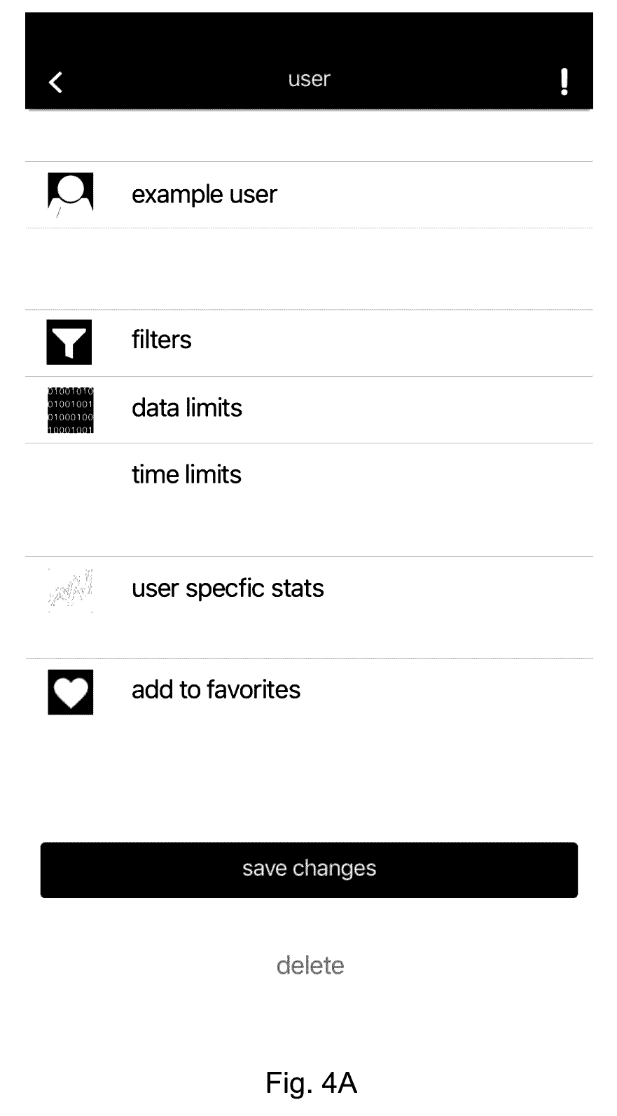

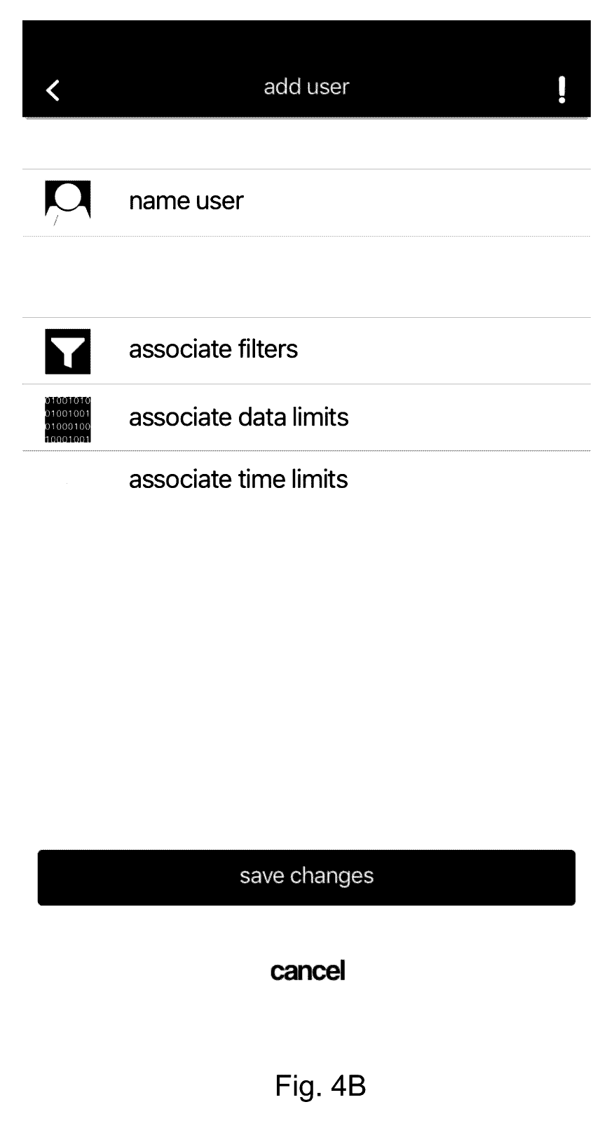

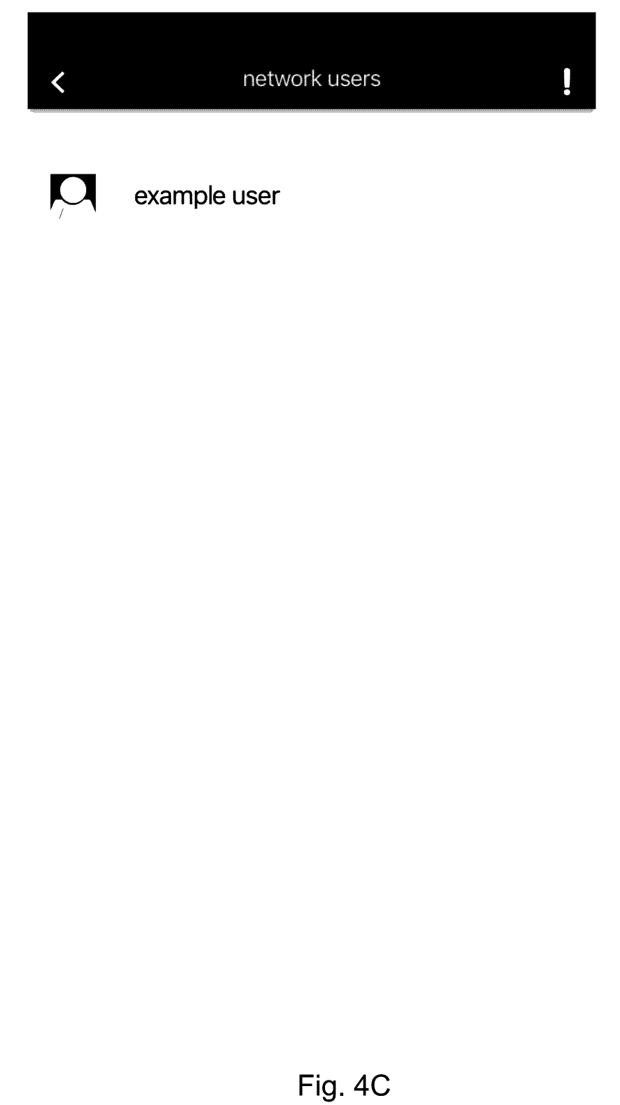

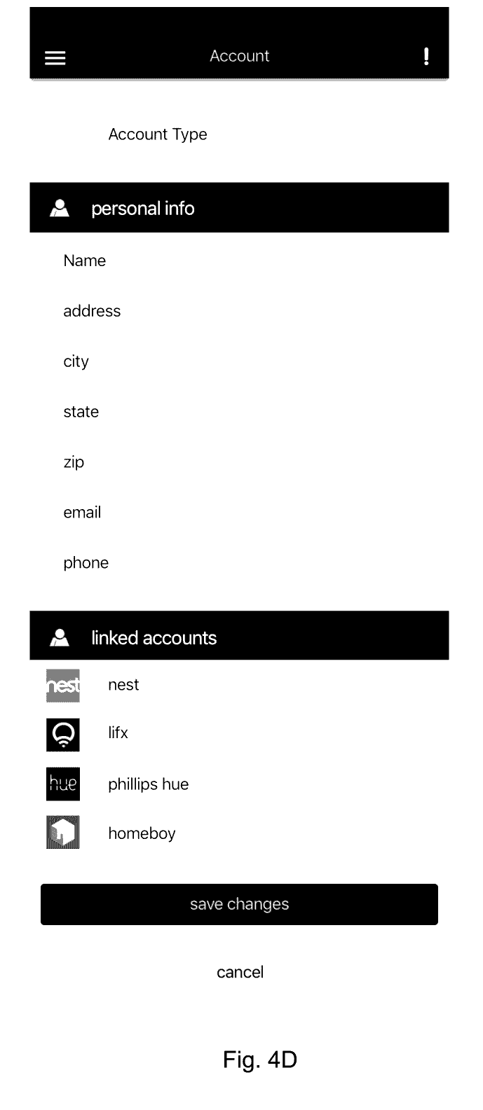

FIGS. 4A-4D illustrate exemplary diagrams of user processes for a controller device according to an embodiment.

In an embodiment, each user may setup various preferences and limits for his or her use of the system. For example, user specific limits may include certain data or time limits (for specific controllable device or generally controllable devices in the aggregate). In another example, user preferences may be applied to the controllable devices through the use of filters. Further examples of the user preferences and limits are discussed below with respect to the relevant figures. In an embodiment, each user may also review statistics with his or her use of the system.

Referring to FIG. 4D, the user may also link other accounts for controlling controllable devices with the system's account. For example, certain controllable devices may allow the user's control through their own apps in a communication device (e.g., Nest, Lifx, Phillips Hue, and Homeboy). Linking with these accounts allows the system to control these controllable devices through their interfaces.

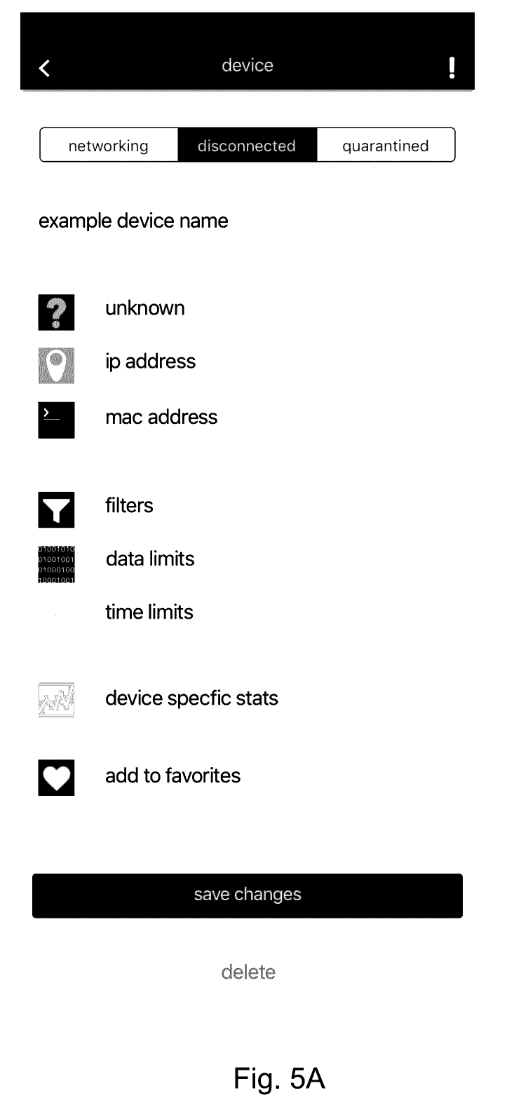

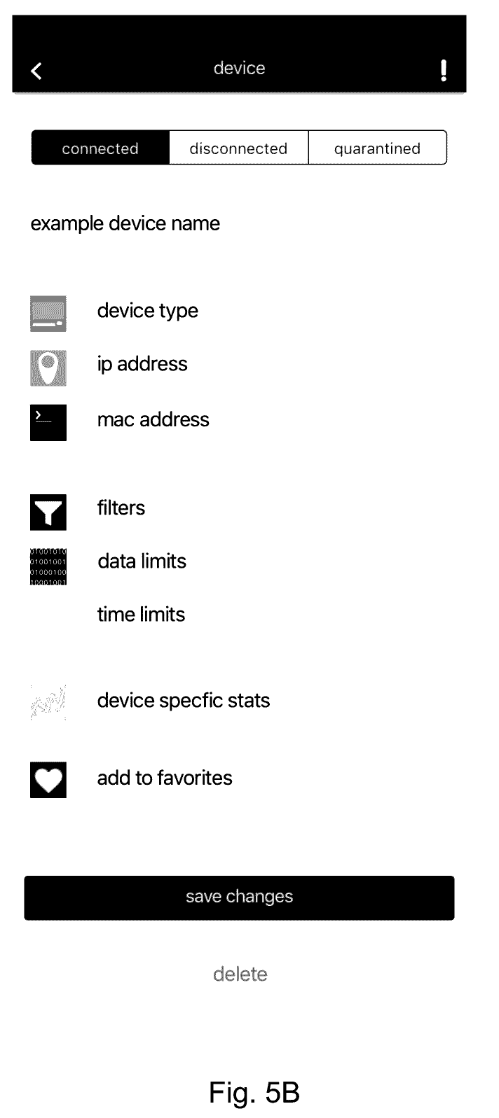

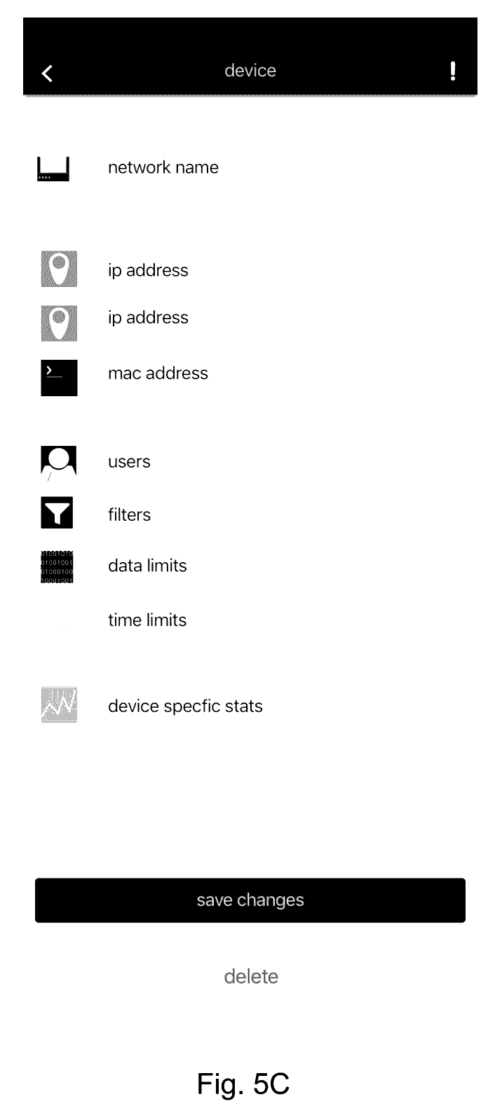

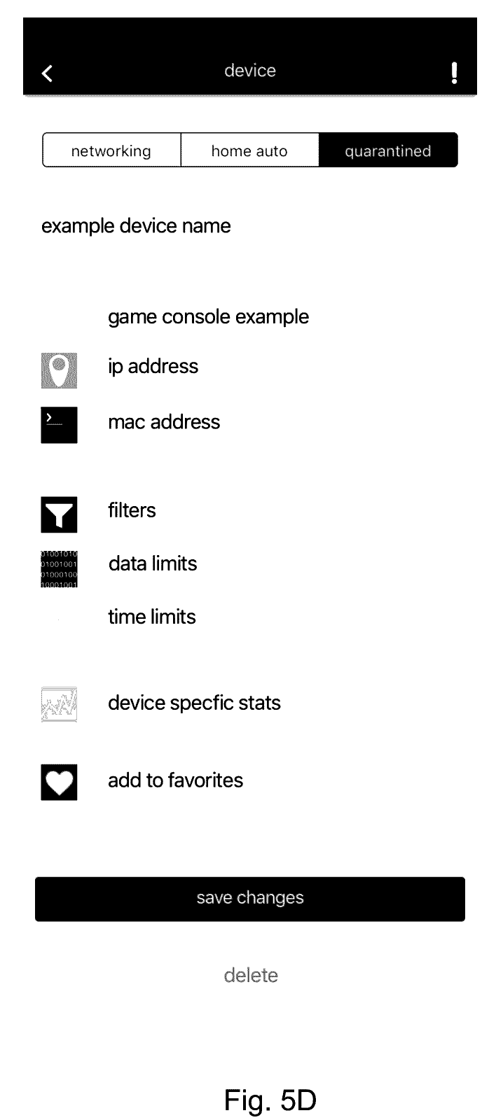

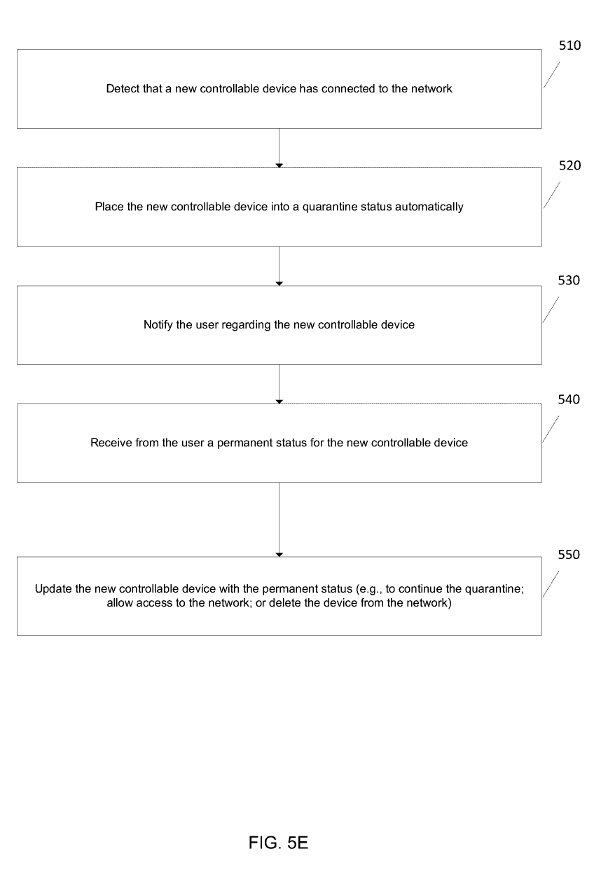

FIGS. 5A-5E illustrate exemplary diagrams of device processes for a controller device according to an embodiment.

FIG. 5A illustrates an exemplary information and setting for a disconnected device. FIG. 5B illustrates an exemplary information and setting for a connected device. FIG. 5D illustrates an exemplary information and setting for a quarantined device. FIG. 5C illustrates an exemplary information and setting for a device.

FIG. 5E illustrates an exemplary flow diagram for a process of adding and updating a connection for a controllable device to the network.

In an embodiment, it is a wanted feature to add and control only certain devices within detectable and communicable by the network. For example, the network (e.g., the router and/or the controllable device) may have an extended range to communicate with devices that are outside the physical boundary of the home or building where the network is deployed. As such, it is desirable to allow only those devices that are within the physical boundary of the home or building of the network to be controlled. In another example, it may be desirable to allow control of certain devices for certain users (or the entire network) even if the device is within the physical boundary of the network (e.g., certain specific devices such as appliances may not be needed to be opened to the network but may be controlled directly through their associated apps).

Referring to FIG. 5E, the process starts with detecting that a new controllable device has connected to the network 510. It is noted that the detecting of the connection need not be associated the connection and/or preference of a user (e.g., the controllable device may be detected by the controller device independent of instructions or preference of a user (using a communication device).

When a new controllable device is detected, the new controllable device is placed into a quarantine status automatically 520. In an embodiment, in a quarantine status, the controllable device may be recognized by the controller device and may be allowed limited connection access (e.g., connection to the WAN through the controller device or the LAN in general). However, access to and from the controllable device for other communication devices may be limited (e.g., limited to no access or to limited functionalities of the controllable device such as only viewing the information and/or status of the controllable device).

The user is then notified regarding the new controllable device 530. In an embodiment, users that are designated as an administrator or other authorized users may be notified regarding the detected new controllable device. The notification may be in the form of an alert to the user's communication device (e.g., an alert to the app), email, text, or other forms of notification as authorized by the user. The notification may occur even if the user is not connected to the LAN. In another embodiment, users (or a subset of the users) connected to the LAN may be notified.

The controller device may receive from the user a permanent status for the new controllable device 540. After the notification in step 530, the notified user (or a subset of the notified user such as an administrator or other authorized users) may attribute a permanent status for the new controllable device. For example, the user may recognize the controllable device as belonging to the network and allow a connection of the controllable device to the network to be accessible. Alternatively, the user does not recognize the controllable device as belonging to the network and may disallow a connection of the controllable device to the network (or allow the connection but restrict access to and from the controllable device for the controller device). In another option, the user may ignore or set aside making a decision of the permanent status at this point. In this case, the new controllable device may stay in the quarantine status until the user makes a decision and/or another authorized user changes the status.

In step 550, the new controllable device is updated with the received status for the device (e.g., to continue the quarantine, allow access to the network (or controller device), or delete or disallow access to the network (or controller device).

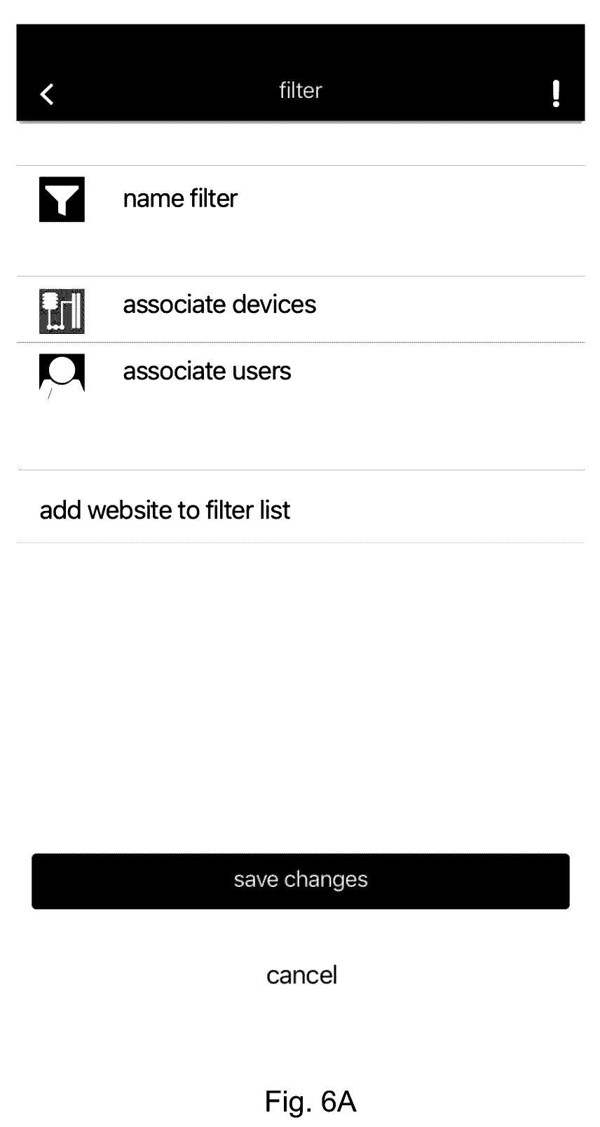

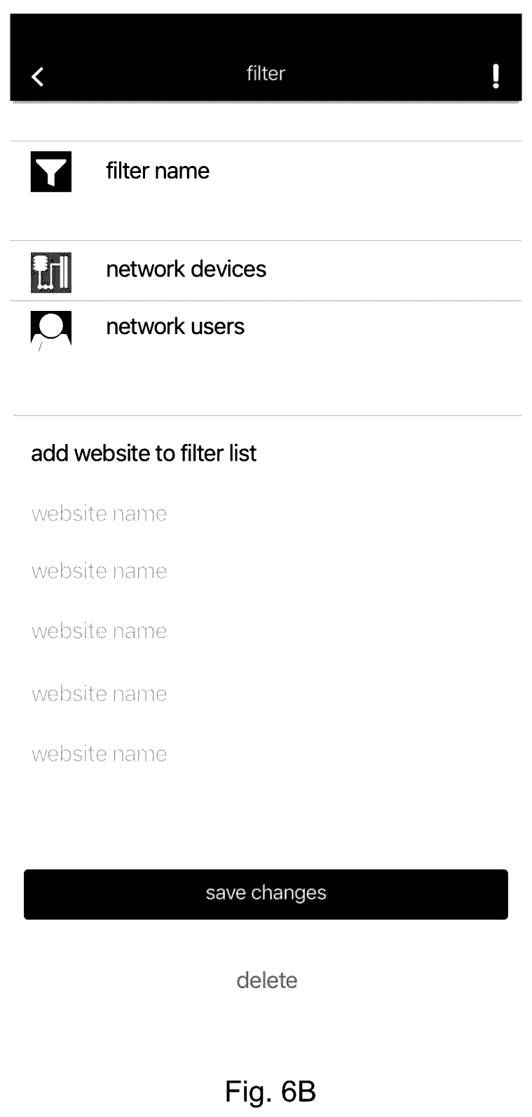

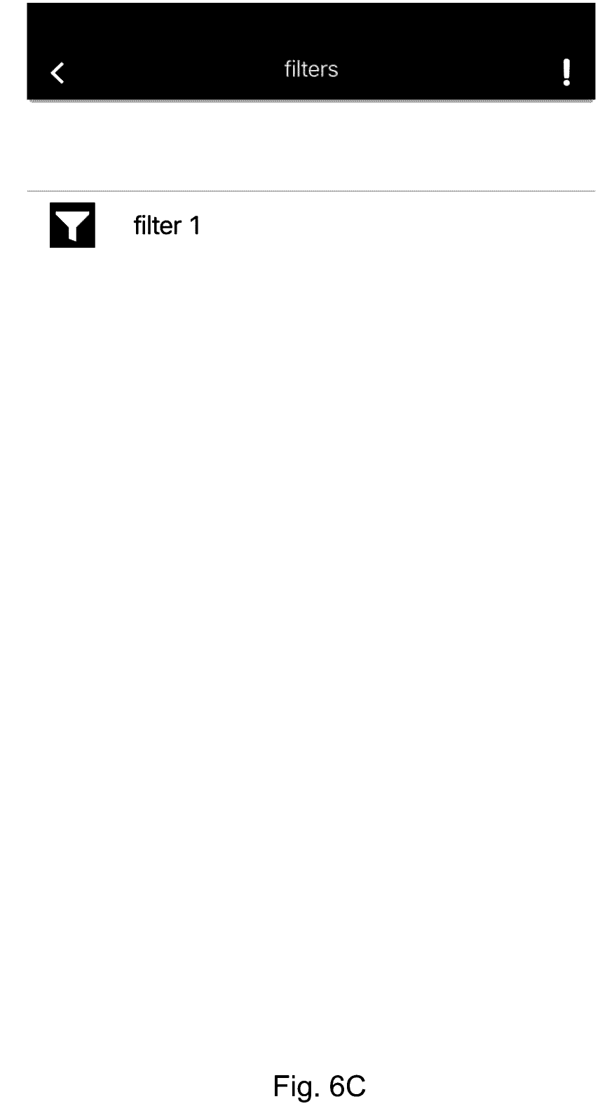

FIGS. 6A-6C illustrate exemplary diagrams of filter processes for a controller device according to an embodiment.

FIG. 6A illustrates an exemplary diagram for a filter process for associate devices and users. FIG. 6B illustrates an exemplary diagram for a filter process for network devices and users. FIG. 6C illustrates an exemplary diagram for a filter list process.

In an embodiment, a filter can be created for certain devices and users (or grouping of devices and users). For example, devices may be filtered by the types of devices, their physical locations in a room, or by other attributes. In another example, users may be filtered by the types of user (e.g., administrators, authorized users, temporary users, etc.).

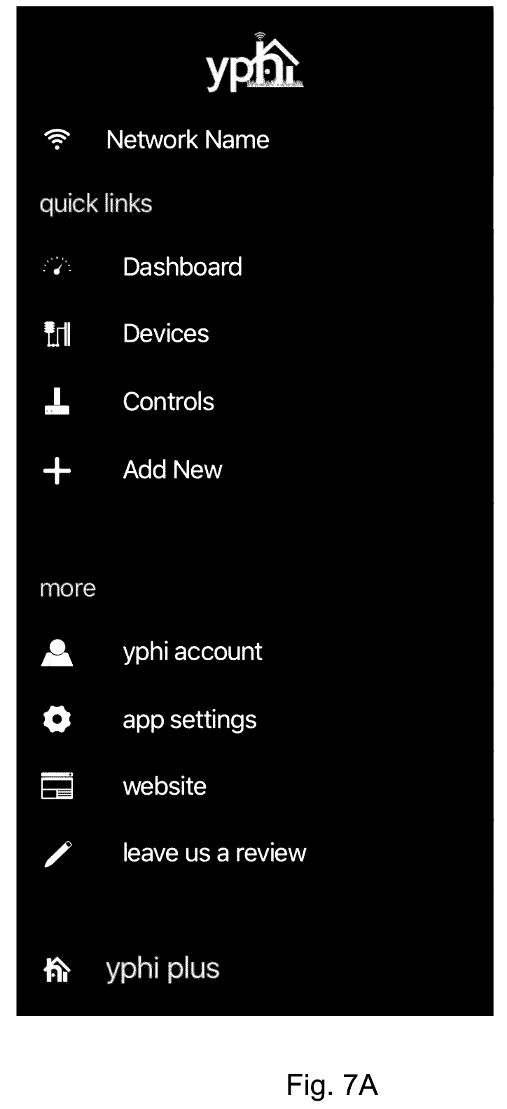

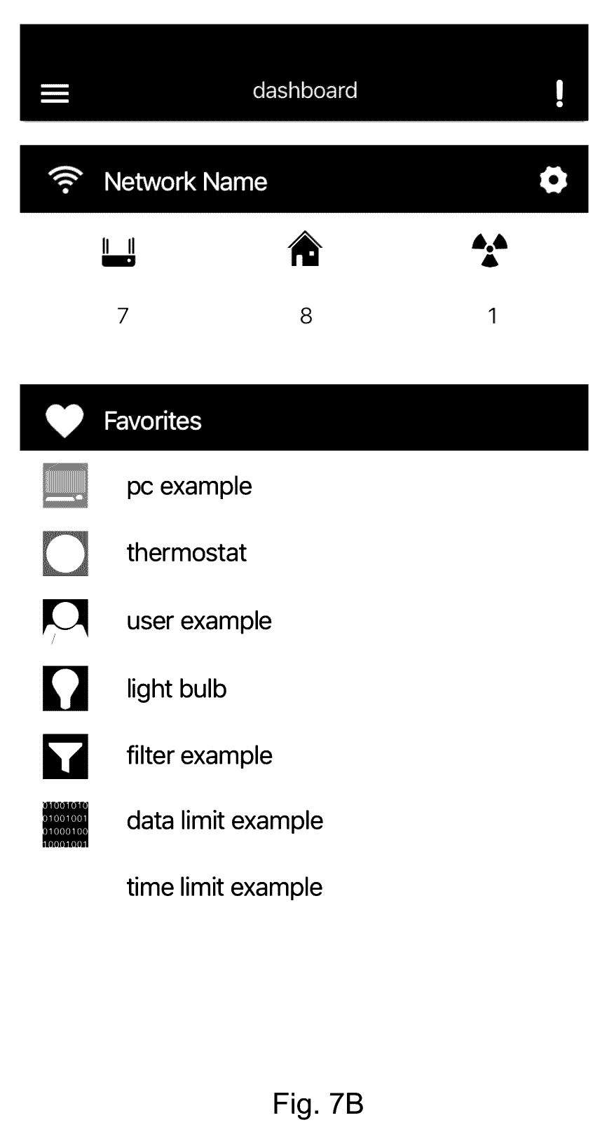

FIGS. 7A-7B illustrate exemplary diagrams of navigation processes for a controller device according to an embodiment.

FIG. 7A illustrate an exemplary diagram for an account navigation process for a user. FIG. 7B illustrates an exemplary diagram for a navigation dashboard process for a user.

In an embodiment, the access to the network, controller device, and the controllable devices for a user is based on an account for the user (and accessible from the user's communication device, e.g., through the app on the communication device). Through the app accessing the account of the user, the user may access the LAN (e.g., as through the controller device) and the access and/or control the controllable devices

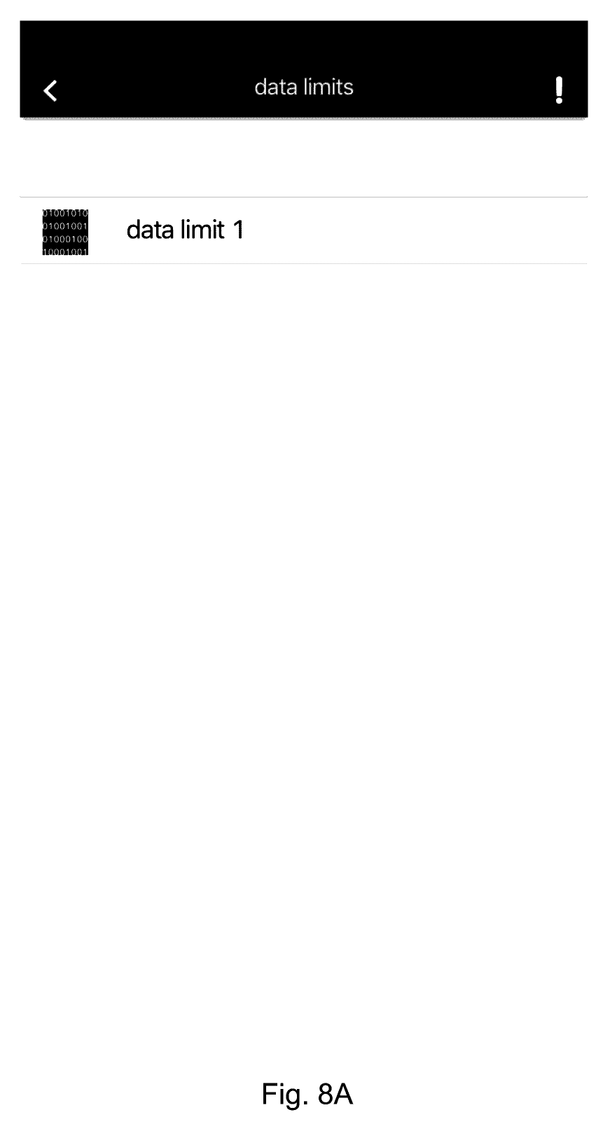

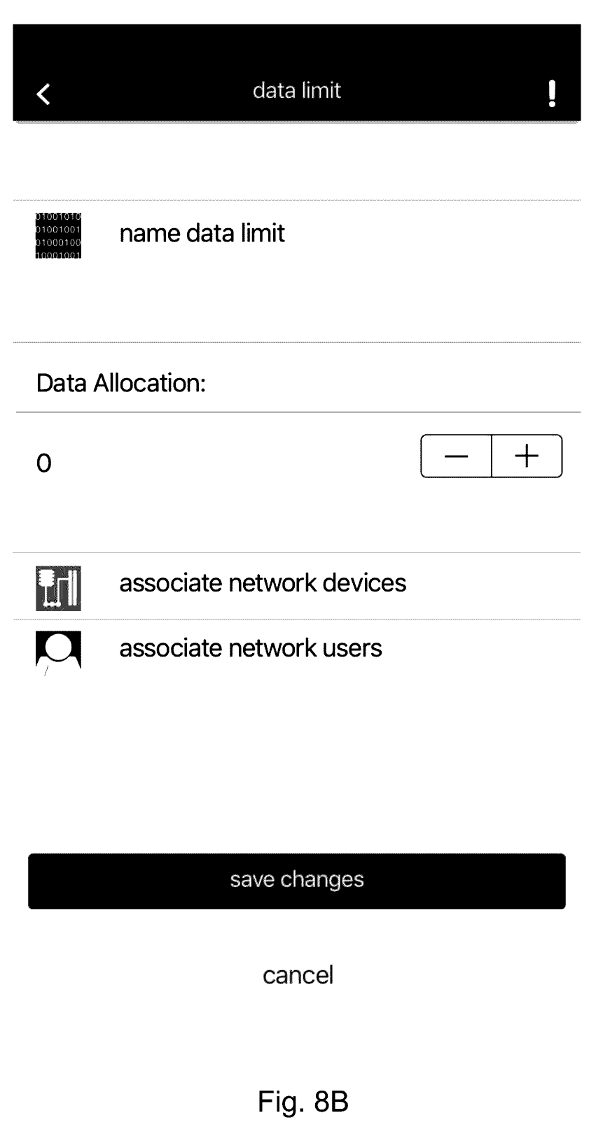

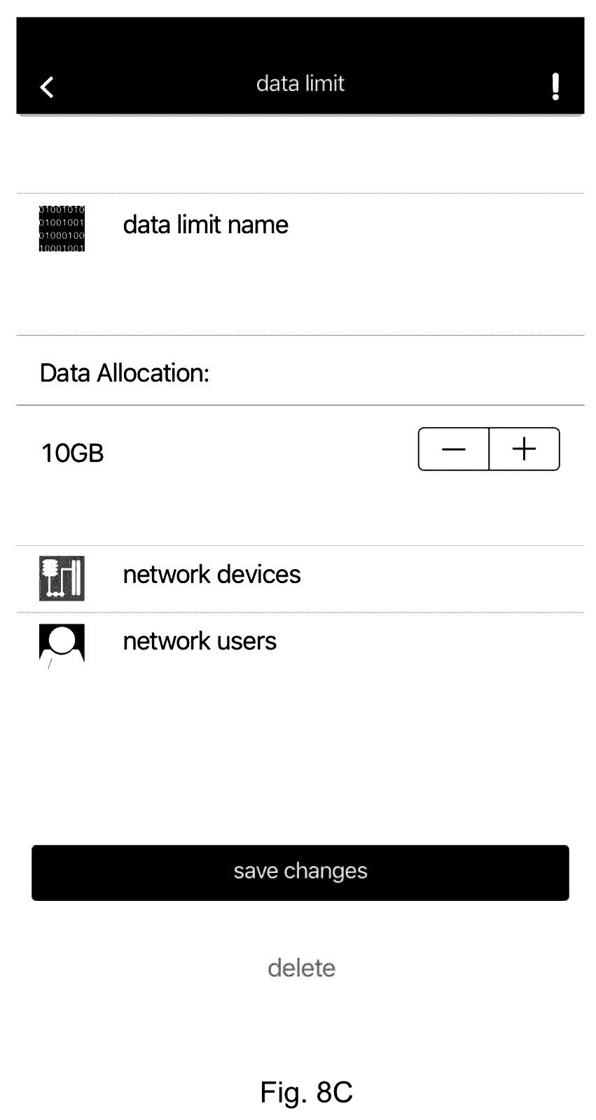

FIGS. 8A-8C illustrate exemplary diagrams of data limit processes for a controller device according to an embodiment.

FIG. 8A illustrates an exemplary diagram for a data limit list process. FIG. 8B illustrates an exemplary diagram for a data limit process for associate devices and users. FIG. 8C illustrates an exemplary diagram for a data limit process for network devices and users.

In an embodiment, the controller device (e.g., a router) may apply certain data limit to the various controllable devices and/or communication devices. This limit may be applied for access to the WAN and/or within the LAN. In an embodiment, data limit may also be applied to the users (e.g., restricting the data usage to the user account as opposed to the communication device).

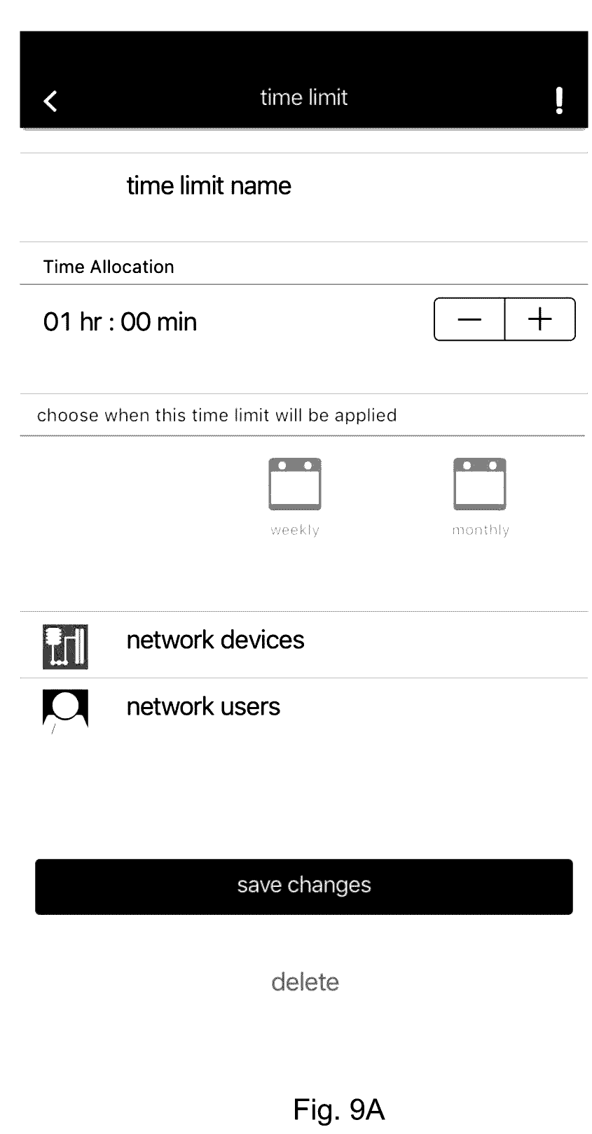

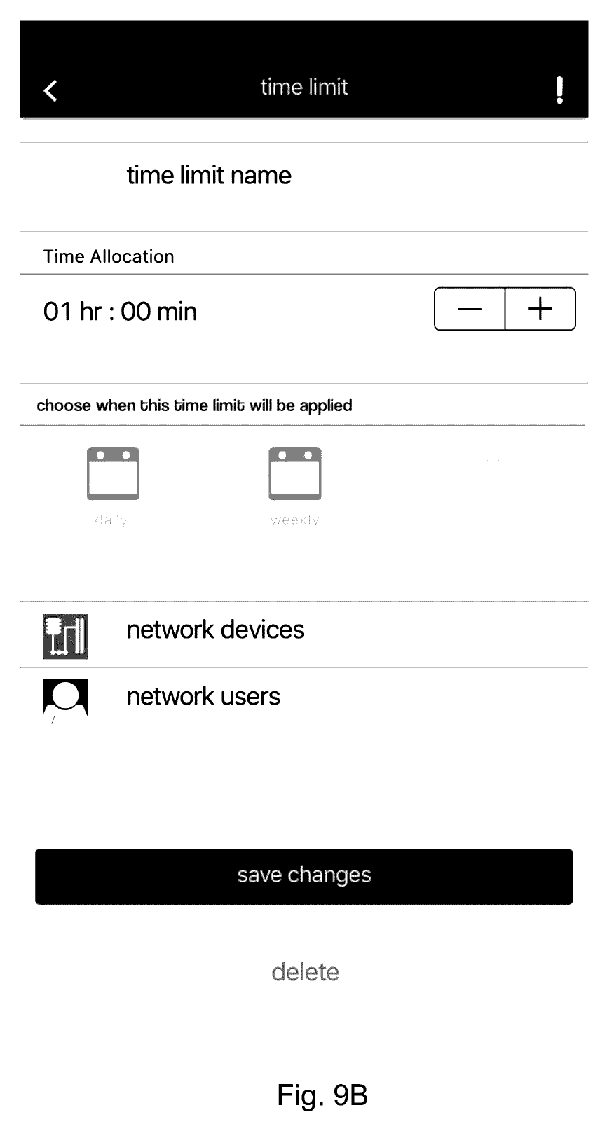

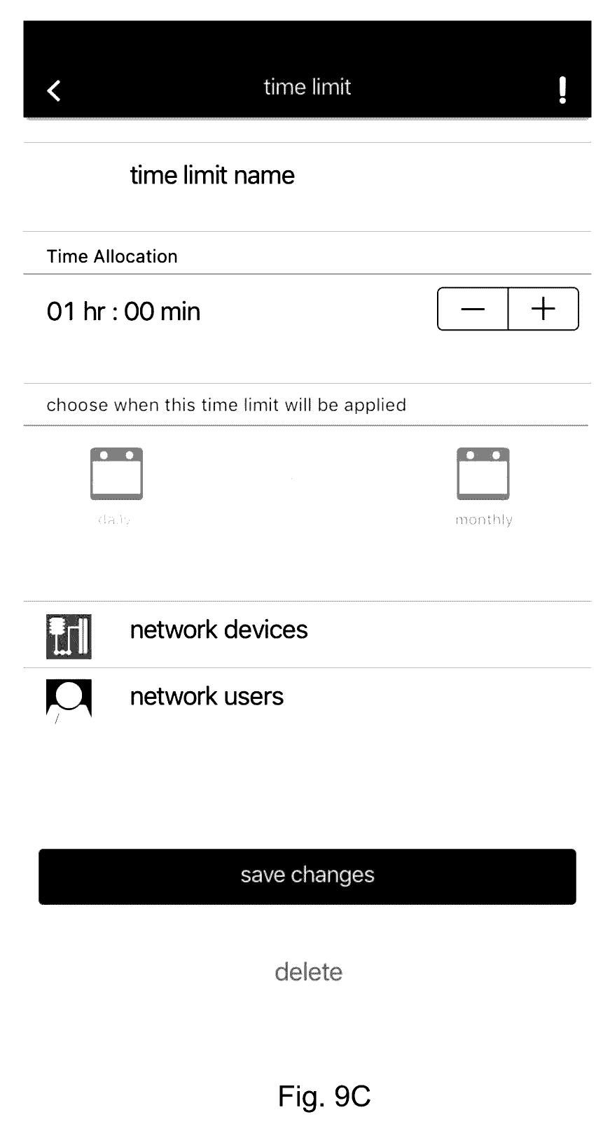

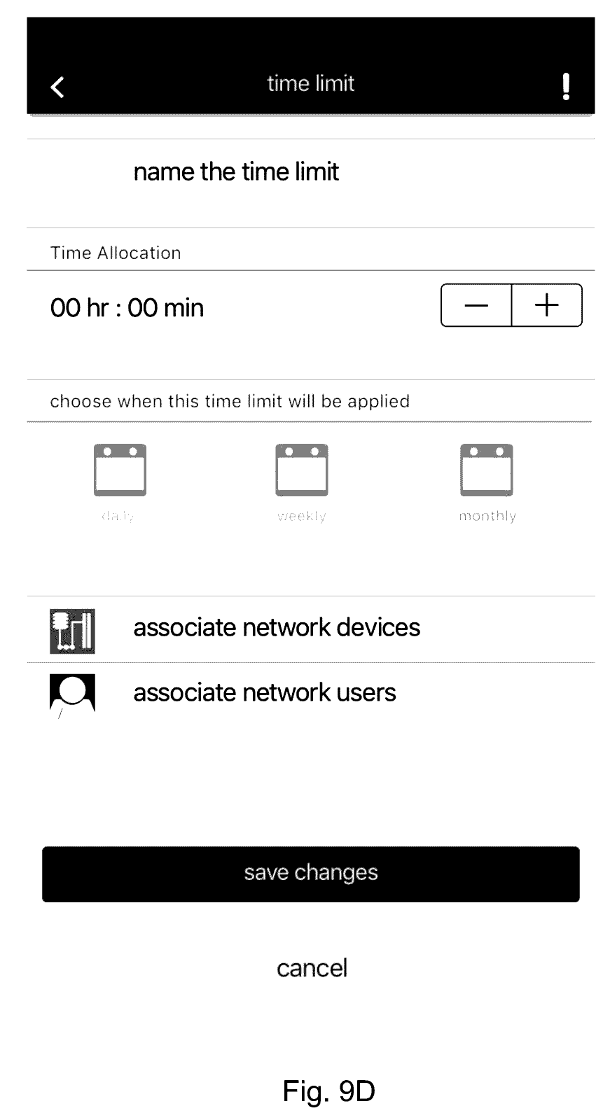

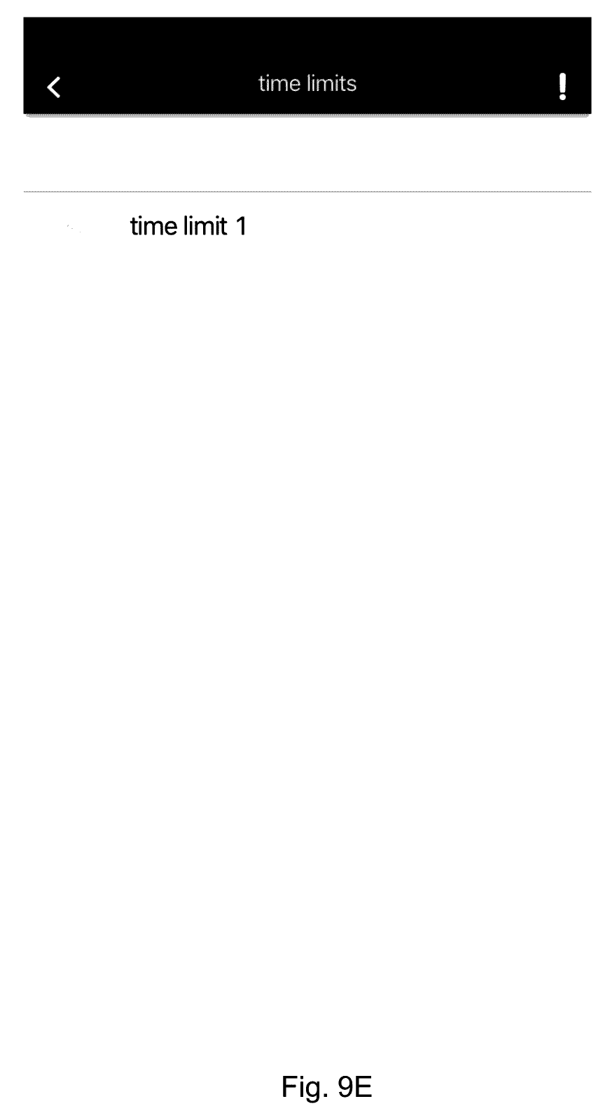

FIGS. 9A-9E illustrate exemplary diagrams of time limit processes for a controller device according to an embodiment.

FIG. 9A illustrates an exemplary diagram for a daily time limit process. FIG. 9B illustrates an exemplary diagram for a monthly time limit process. FIG. 9A illustrates an exemplary diagram for a weekly time limit process. FIG. 9D illustrates an exemplary diagram for a time limit process for associate devices and users. FIG. 9E illustrates an exemplary diagram for a time limit list process.

In an embodiment, the controller device (e.g., a router) may apply certain time limit to the various controllable devices and/or communication devices. For example, access to and from the controllable devices and/or communication devices may be restricted to certain time allocation (of access or accessibility) within a time period (e.g., per day, week, month, or other time periods). Similarly, a user may be limited to certain time allocation within a time period. In another example, the devices may be limited to access or accessibility within or outside of certain time period (e.g., limited to access from dusk to dawn).

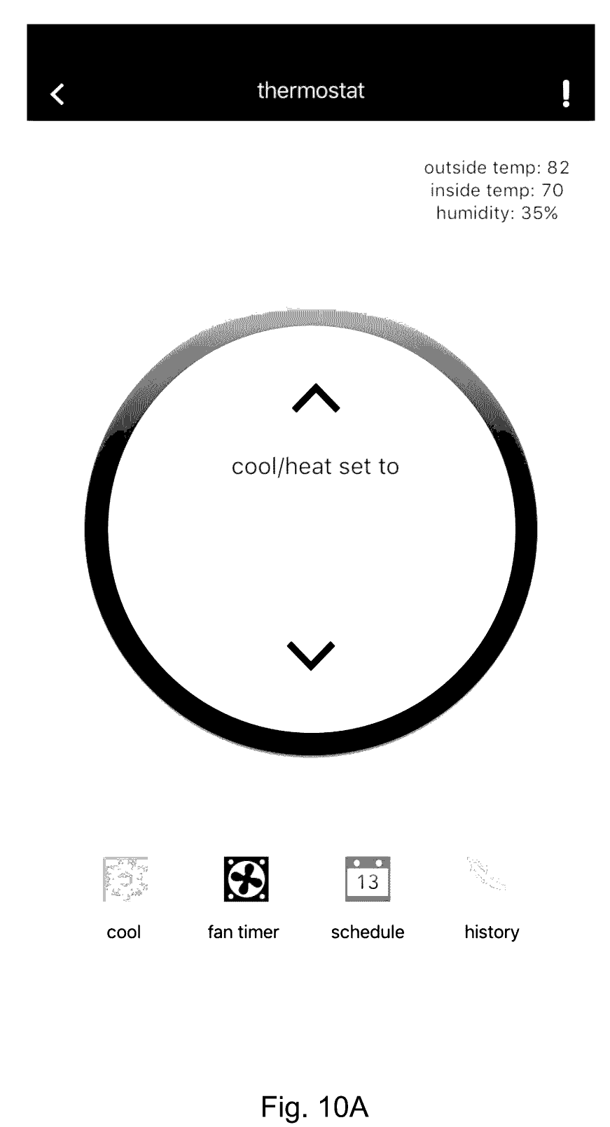

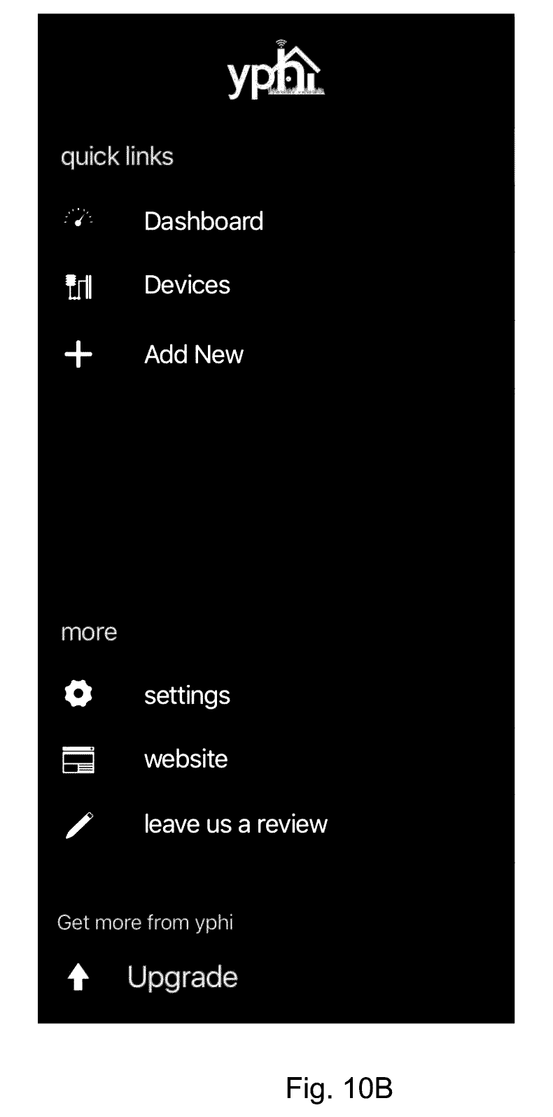

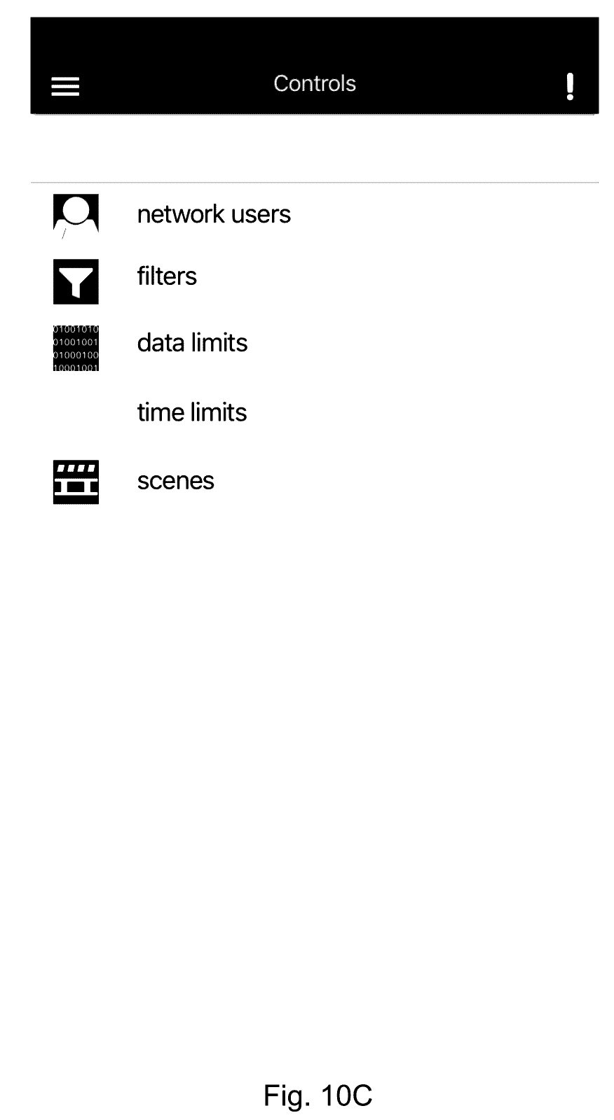

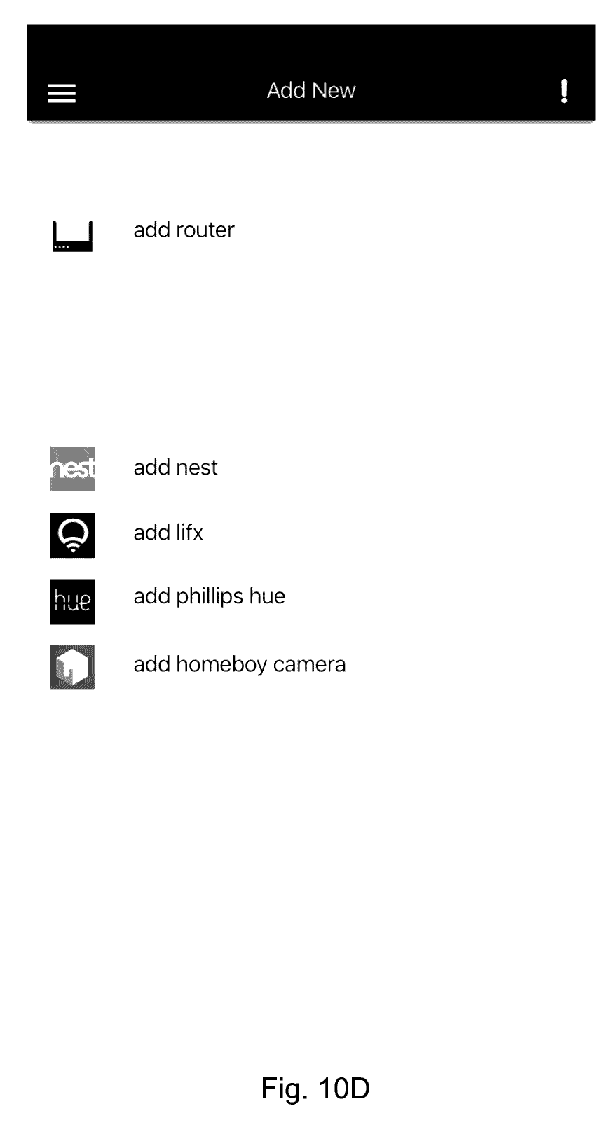

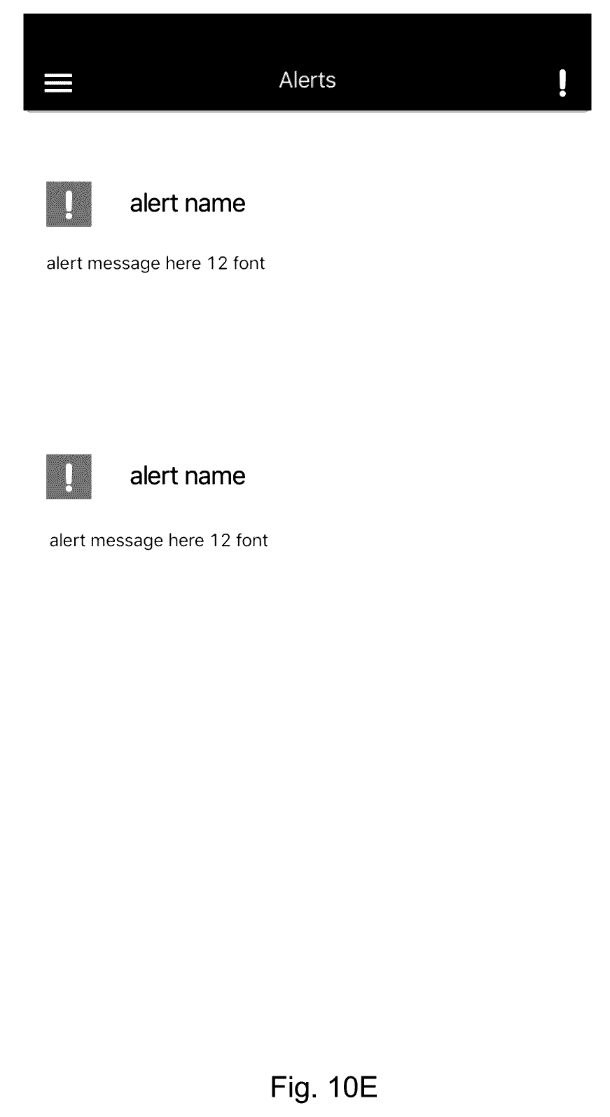

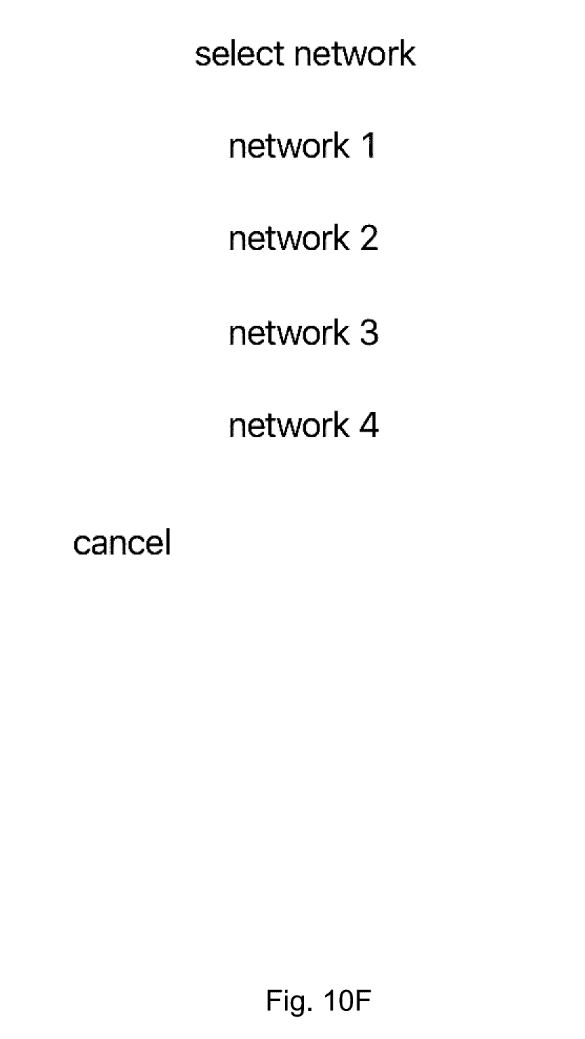

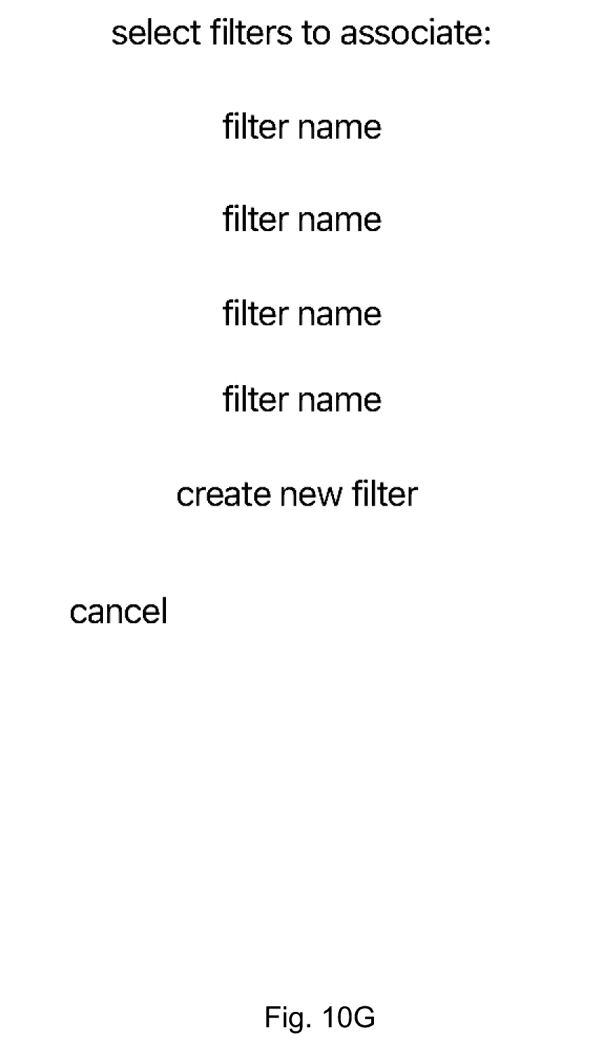

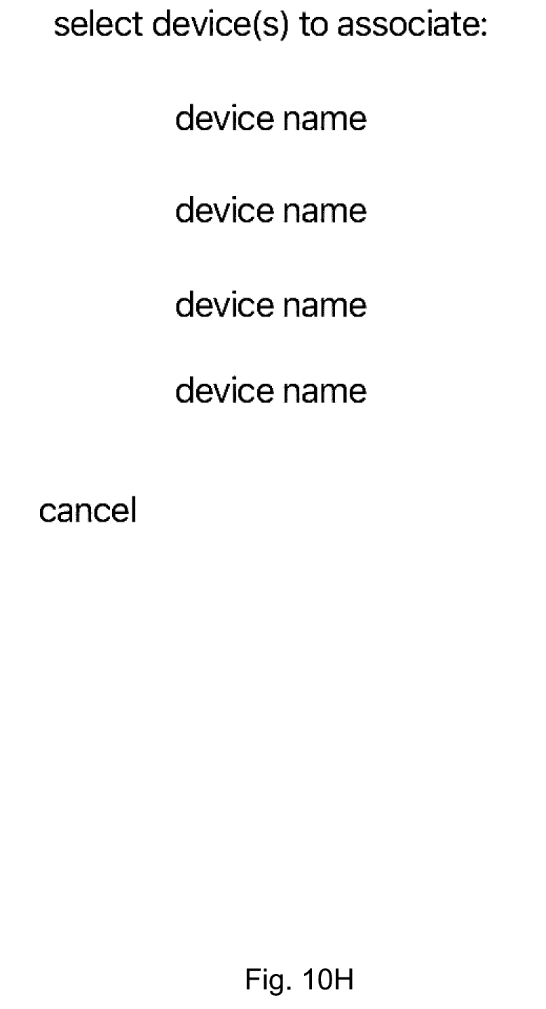

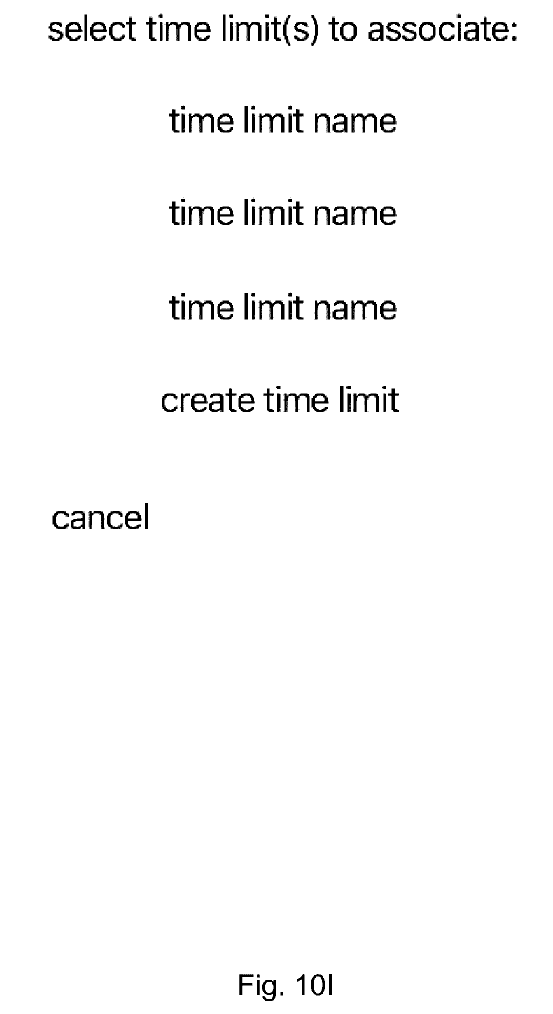

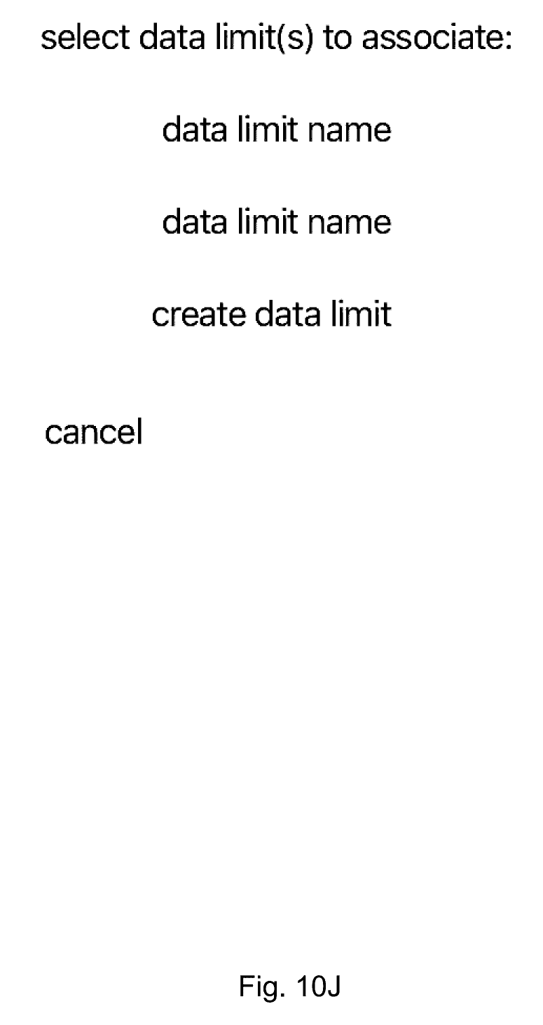

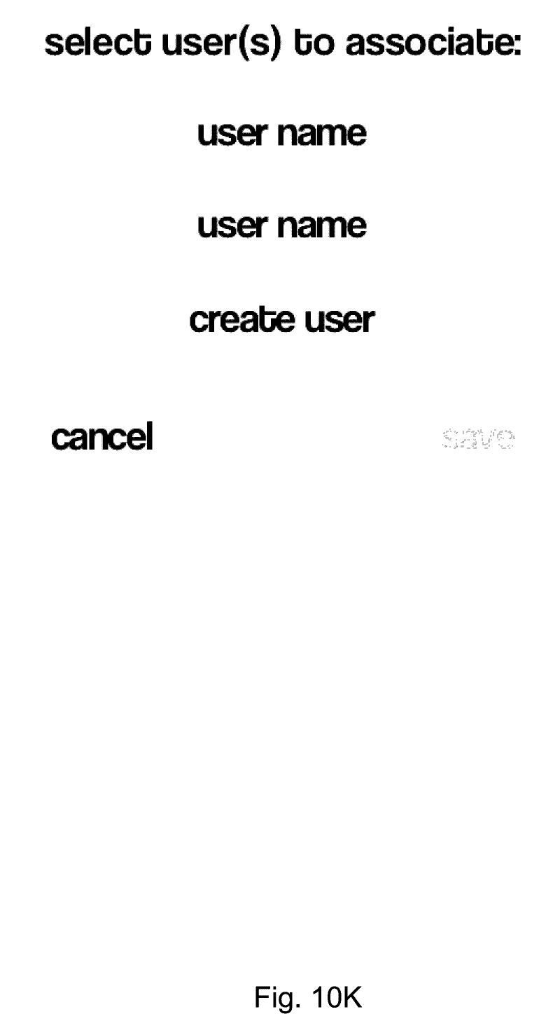

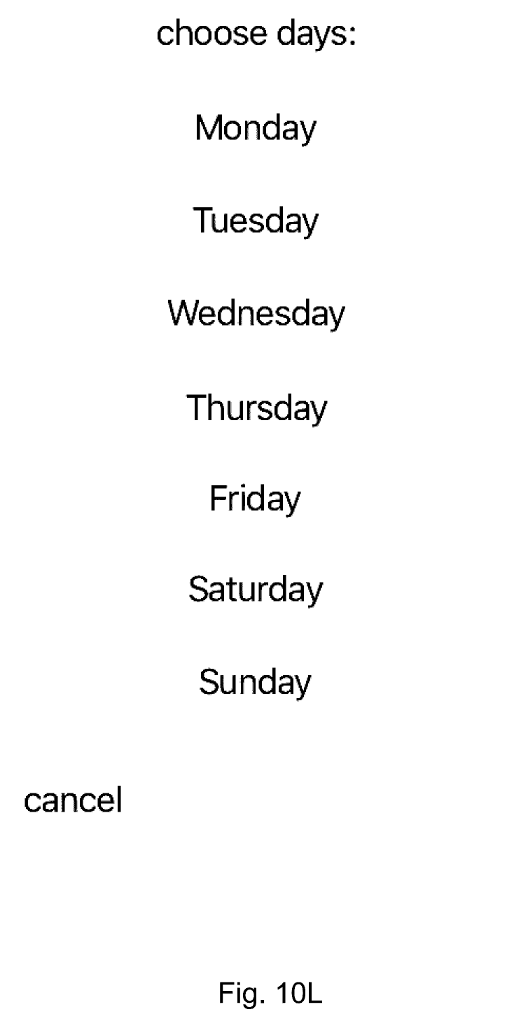

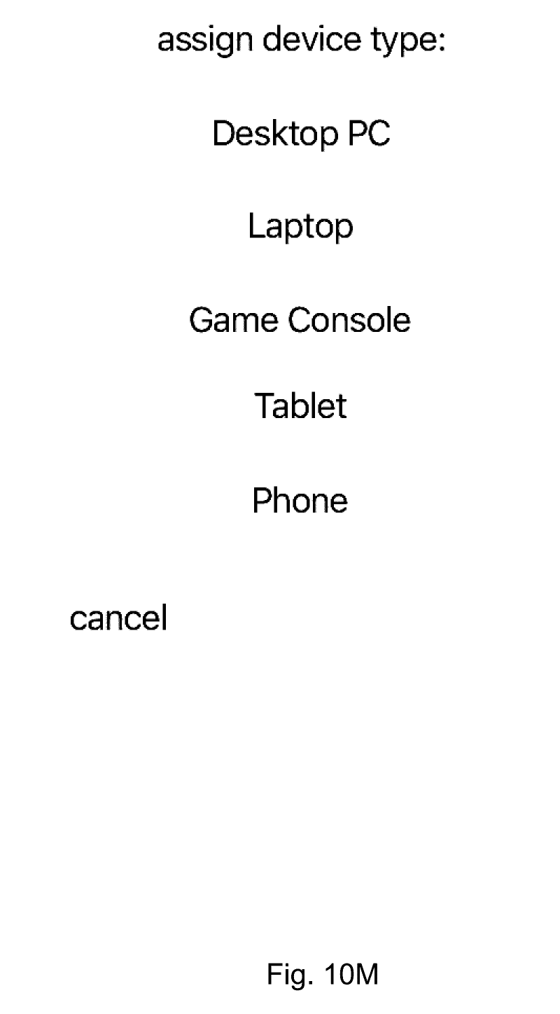

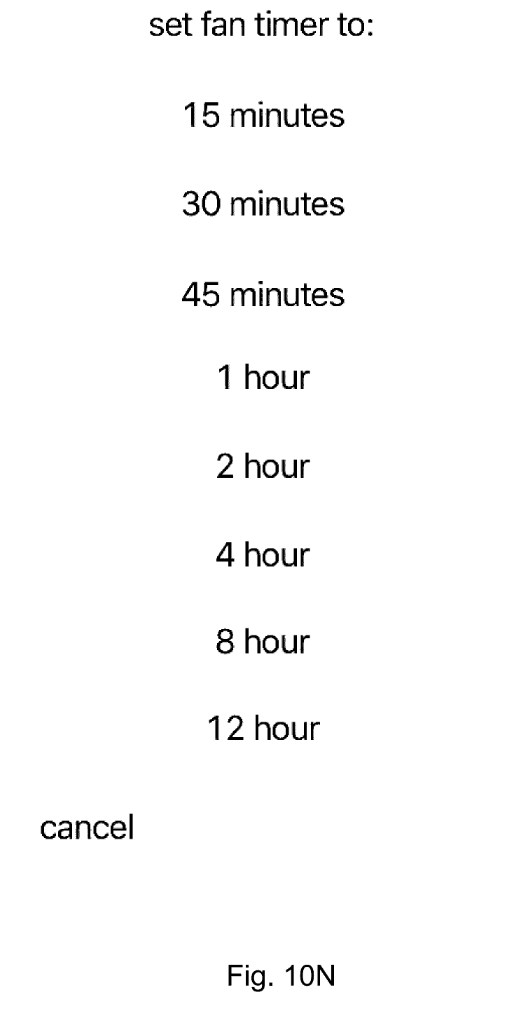

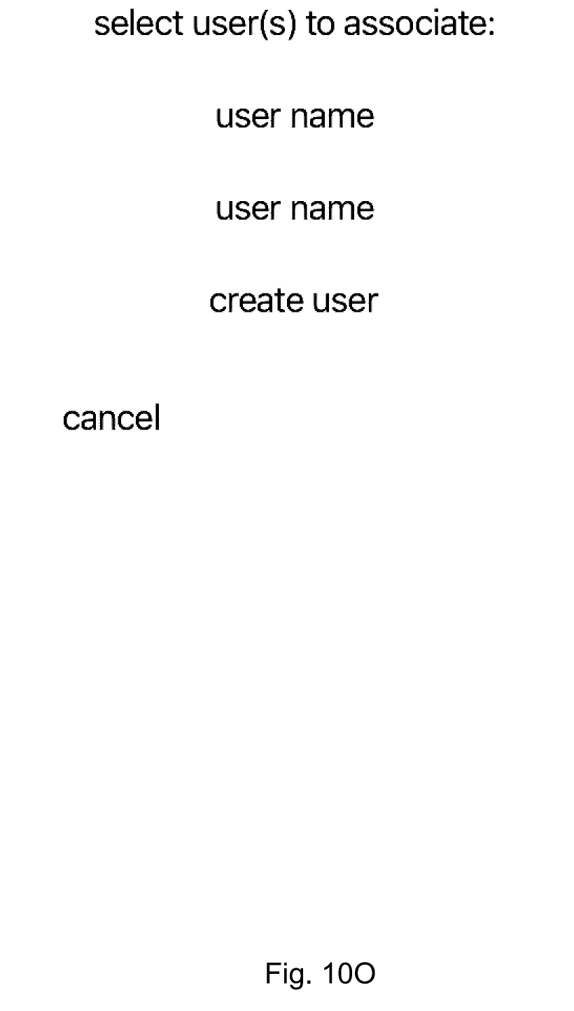

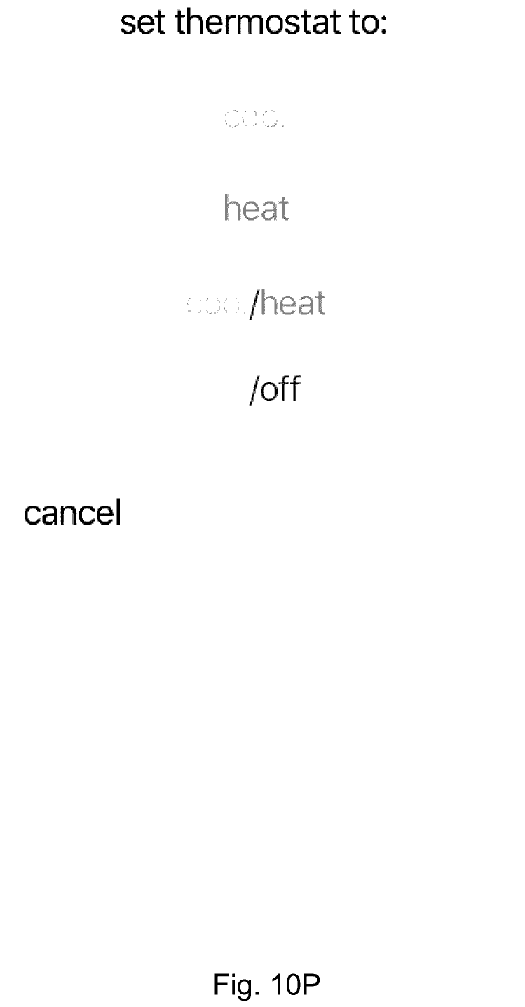

FIGS. 10A-10P illustrate exemplary diagrams of device control processes for a controller device according to an embodiment.

FIG. 10A illustrates an exemplary diagram of a thermostat device specific control process. FIG. 10B illustrates an exemplary diagram of a user account process. FIG. 10C illustrates an exemplary diagram of a setting control process. FIG. 10D illustrates an exemplary diagram of an adding process for controller and controllable devices. FIG. 10E illustrates an exemplary diagram of an alert process. FIG. 10F illustrates an exemplary diagram of a network selection process. FIG. 10G illustrates an exemplary diagram of a filter selection process. FIG. 10H illustrates an exemplary diagram of a device association process. FIG. 10I illustrates an exemplary diagram of a time limit association process. FIG. 10J illustrates an exemplary diagram of a data limit association process. FIG. 10K illustrates an exemplary diagram of a user association process. FIG. 10L illustrates an exemplary diagram of a date selection process. FIG. 10M illustrates an exemplary diagram of a device type selection process. FIG. 10N illustrates an exemplary diagram of a fan timer device attribute selection process. FIG. 10O illustrates an exemplary diagram of a user association selection process. FIG. 10P illustrates an exemplary diagram of a thermostat device attribute selection process.

In an embodiment, an app on the user's communication device is able to provide an (graphical) interface for controlling the various controllable devices. For example, the user may be able to control the various functions of thermostat devices through the app. These control functions may be provided through a function library from the manufacturer of the controllable device (e.g., through library functions or apps provided with the controllable device). In an embodiment, the app may also access and display relevant information (e.g., outside temperature, inside temperature, humidity for a thermostat) provided by the controllable device or accessible from other sources (e.g., the Internet).

In an embodiment, control functionalities may be limited by a combination of filters, data limits, and time limits (each of these functionalities limitations as discussed above. For example, a set of controllable devices may be grouped by a filter and have a common data and/or time limit. Similarly, each user may have specific preferences in his or her user account for various sets of controllable devices as grouped by filters and have their data and/or time limit.

In an embodiment, the network (or a number of networks) may include a number of controller devices (routers). The user may select through the app a controller device (to control the controllable devices) organized by that controller device. The user may also select the network (or a number of networks) he or she wants to connect to (for controlling the controllable devices of that network).

In an embodiment, specific controllable devices may be added to be managed by the controller device. For example, the app may include functions for supporting specific devices, through the library and/or other specific codes/scripts for those devices (e.g., Nest, Lifx, Phillips Hue, Homeboy Camera). In another embodiment, specific communication devices and/or types of communication devices may be specifically supported. For example, a desktop PC, a laptop, a game console, a tablet, or a phone may support different types of apps and/or application (to interface with the controller device). The expected control functionalities (to control the controllable devices) may also be different depending on the type of device (e.g., a game console may have limited functionality to control limited devices, for example, dimming of lights when the game console is active, e.g., the user is playing a game in the room).

In an embodiment, alerts may be produced and displayed on the communication devices regarding the controller device or the controllable devices. Certain events may trigger alerts, such as when new devices are added, removed, and/or quarantined. Other events that may trigger alarms and/or alerts include user events, data limits, time limits, and filters.

In an embodiment, the alerts may also trigger advertisements for various products. For example, the app may have statistics on how many hours a user is using a specific device and calculate how much energy the user is using on a monthly basis based on the products said energy usage. From this data, the app may recommend a new product such as another light bulb and let the user know how much money they can save monthly by purchasing one. In an embodiment, the strategically placed advertisements within the app may have links and information based on the product recommended to be purchase. Also, various statistics, data sheets, and/or projection based on how many of specific device the user purchased and how much the user can save may be displayed.

In an embodiment, the groupings of the various controllable devices (e.g., the various devices in a physical room) may be grouped to create for a specific “scene” for the devices in the room. For example, all the connected devices in a living room may be used to create a scene (e.g., when the game console or an audio-visual system is active, the lighting devices may be dimmed and a device controlling curtains may close to provide a darkened environment in the room). In a further embodiment, the activation and deactivation of a scene may be automatic depending on the detection of the user in a room (with the grouping of the controllable devices in the scene). This may be detected, for example, by the way of detecting the communication device being in the same room as the grouped controllable devices. In another example, HVACs may be automatically turned off when the user leaves the room and automatically turned on when the user is present in a room.

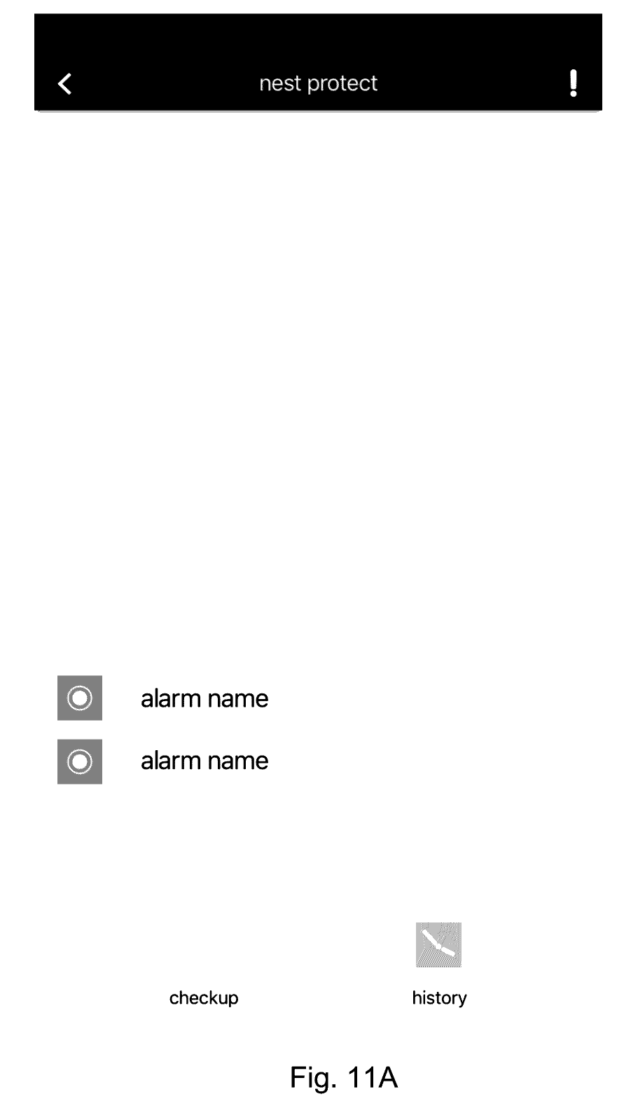

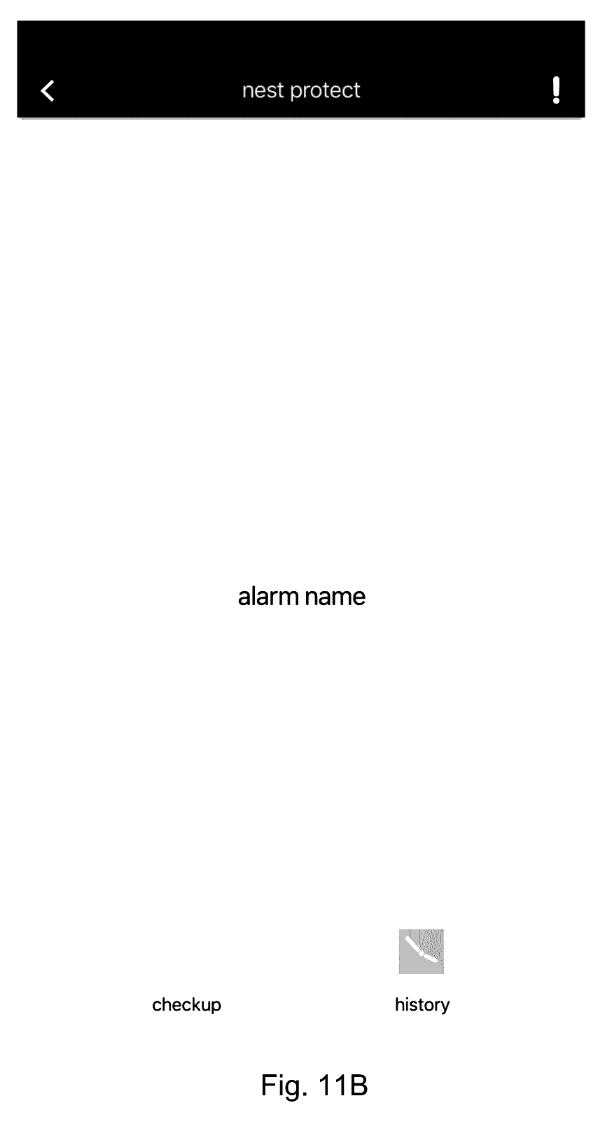

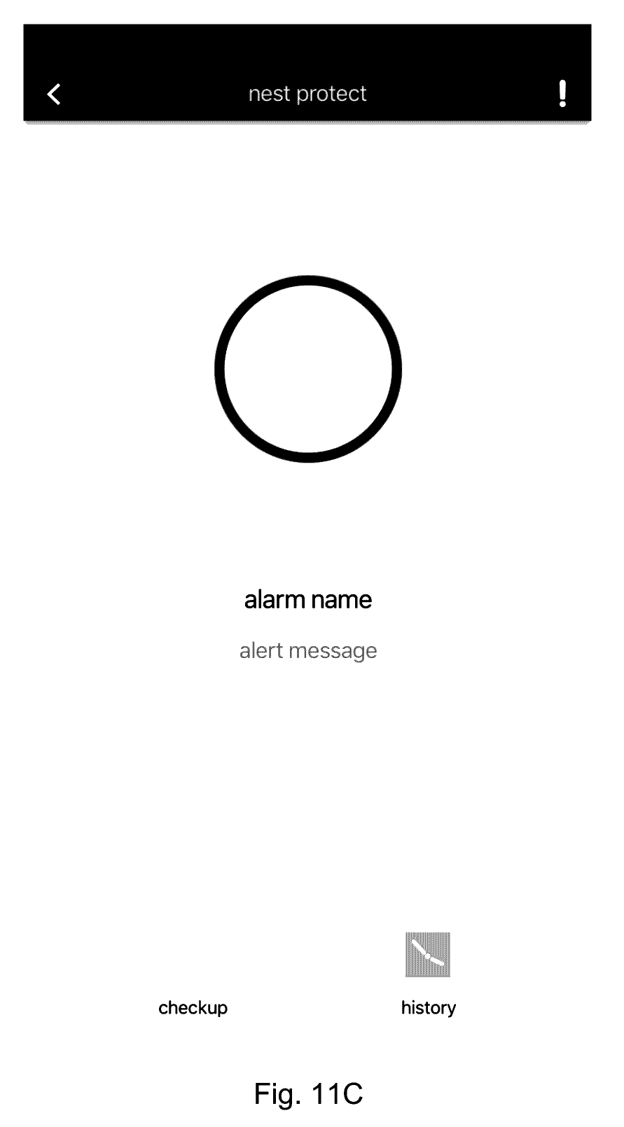

FIGS. 11A-11C illustrate exemplary diagrams of alarm processes for a controller device according to an embodiment.

In an embodiment, alarms and/or alerts may be produced and displayed on the communication devices regarding the controller device or the controllable devices. Certain events may trigger alarms and/or alerts, such as when new devices are added, removed, and/or quarantined. Other events that may trigger alarms and/or alerts include user events, data limits, time limits, and filters.

In an embodiment, alarms and/or alerts may be triggered by other applications and/or interfaces. For example, a controllable device that works with another application (e.g., a Nest device working with a Nest application) may generate its own alarms and/or alerts for various events. The app on the communication device may capture and/or receive their events and produce similar alarms and/or alerts for these events within the app for the user.

To avoid unnecessarily obscuring the present disclosure, the preceding description may omit a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as a discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for controlling network devices, comprising:
a controller device coupled to a local area network (LAN) and a wide area network (WAN); and
a communication device including a communication interface, the communication device in communication with the controller device through the communication interface, wherein
the controller device communicates with one or more controllable devices using network transmissions through the LAN, the controllable devices each controls at least one functionality of a device of a building, wherein
the network transmissions include transmissions for transmitting an instruction from the controller device to the controllable devices or receiving information from the controllable devices to the controller device, wherein
communications between the communication device and the controller device include communications regarding the controllable devices, wherein
the controller device provides at least one device connected through the LAN access to the WAN, and wherein
the communication interface provides a user of the communication device control of at least one of the controllable devices.

2. The system of claim 1, wherein
the communication interface provides a notification to the user regarding a newly connected of the controllable devices, wherein
the newly connected device is placed into a quarantine status by the controller device, and wherein
the communication interface provides the user options to allow the newly connected device as permanently connected, reject the newly connected device as permanently connected, or continue the quarantine status.

3. The system of claim 1, wherein
the communication interface provides an alert to the user regarding an event to the controllable devices.

4. The system of claim 3, wherein
the event includes one of (a) one of the controllable devices being placed into a quarantine status; (b) the communication device or the one controllable devices reaching a limit of data transferred or time activated; (c) an activation of an advertisement; and (d) an alert from an external application for the one controllable device.

5. The system of claim 1, wherein
a set of the controllable devices are grouped by the controller device, and wherein
the communication interface provides the user a common control for the set.

6. The system of claim 5, wherein
each device of the set are automatically controlled by the controller device to a predetermined setting when a configuration among the controllable devices, the communication device, the controller device, the user, and other circumstances is reached.

7. The system of claim 1, wherein
the user is provided with a user account on the controller device, the user account includes an identification of the user and preferences of the user associated with the controllable devices.

8. A method for controlling network devices, comprising:
providing a controller device coupled to a local area network (LAN) and a wide area network (WAN);
providing a communication device to a user, the communication device including a communication interface;
communicating the communication device with the controller device through the communication interface;
transmitting an instruction from the controller device to one or more controllable devices or receiving information from the controllable devices to the controller device using network transmissions through the LAN; and
providing using the controller device at least one device connected through the LAN access to the WAN, wherein
the controllable devices each controls at least one functionality of a device of a building, wherein
communications between the communication device and the controller device includes communications regarding the controllable devices, wherein
the controller device provides at least one device connected through the LAN access to the WAN, and wherein
the communication interface provides a user of the communication device control of at least one of the controllable devices.

9. The method of claim 8, further comprising:
placing a newly connected of the controllable devices into a quarantine status by the controller device;
providing through the communication interface a notification to the user regarding the newly connected device; and
providing through the communication interface the user options to allow the newly connected device as permanently connected, reject the newly connected device as permanently connected, or continue the quarantine status.

10. The method of claim 8, further comprising:
providing through the communication interface an alert to the user regarding an event to the controllable devices.

11. The method of claim 10, wherein
the event includes one of (a) one of the controllable devices being placed into a quarantine status; (b) the communication device or the one controllable devices reaching a limit of data transferred or time activated; (c) an activation of an advertisement; and (d) an alert from an external application for the one controllable device.

12. The method of claim 8, wherein
a set of the controllable devices are grouped by the controller device, and further comprising:
providing through the communication interface the user a common control for the set.

13. The method of claim 12, further comprising
automatically controlling by the controller device each device of the set to a predetermined setting when a configuration among the controllable devices, the communication device, the controller device, the user, and other circumstances is reached.

14. The method of claim 8, further comprising
providing the user with a user account on the controller device, the user account includes an identification of the user and preferences of the user associated with the controllable devices.

15. A method for controlling network devices, comprising:
providing a controller device coupled to a local area network (LAN) and a wide area network (WAN);
providing a communication device to a user, the communication device including a communication interface;
communicating the communication device with the controller device through the communication interface;
transmitting an instruction from the controller device to one or more controllable devices or receiving information from the controllable devices to the controller device using network transmissions through the LAN;
providing using the controller device at least one device connected through the LAN access to the WAN;
placing a newly connected of the controllable devices is into a quarantine status by the controller device;
providing through the communication interface a notification to the user regarding the newly connected device;
providing through the communication interface the user options to allow the newly connected device as permanently connected, reject the newly connected device as permanently connected, or continue the quarantine status; and
providing through the communication interface an alert to the user regarding an event to the controllable devices, wherein
the controllable devices each controls at least one functionality of a device of a building, wherein
communications between the communication device and the controller device includes communications regarding the controllable devices, wherein
the controller device provides at least one device connected through the LAN access to the WAN, and wherein
the communication interface provides a user of the communication device control of at least one of the controllable devices.

16. The method of claim 15, wherein
the event includes one of (a) one of the controllable devices being placed into a quarantine status; (b) the communication device or the one controllable devices reaching a limit of data transferred or time activated; (c) an activation of an advertisement; and (d) an alert from an external application for the one controllable device.

17. The method of claim 15, wherein
a set of the controllable devices are grouped by the controller device, and further comprising:
providing through the communication interface the user a common control for the set.

18. The method of claim 17, further comprising
automatically controlling by the controller device each device of the set to a predetermined setting when a configuration among the controllable devices, the communication device, the controller device, the user, and other circumstances is reached.

19. The method of claim 15, further comprising
providing the user with a user account on the controller device, the user account includes an identification of the user and preferences of the user associated with the controllable devices.
